(19) United States
(12) Patent Application Publication
(10) Pub. No.: US 2020/0143469 A1
(43) Pub. Date: May 7, 2020

(54) TECHNOLOGICAL IMPROVEMENTS TO NETWORKED COMPUTER SYSTEMS HAVING PARTICULARIZED COMPONENTS THAT ARE SPECIALLY PROGRAMMED TO UNCONVENTIONALLY EFFECTUATE EFFICIENT BLOCKCHAIN STORAGE

(71) Applicant: VEZT,INC., Studio City, CA (US)

(72) Inventors: Steve Stewart, Studio City, CA (US); Roberto M. Menendez, Los Angeles, CA (US)

(73) Assignee: VEZT, INC., STUDIO CITY, CA (US)

(21) Appl. No.: 16/576,998

(22) Filed: Sep. 20, 2019

Related U.S. Application Data
(63) Continuation-in-part of application No. 15/451,287, filed on Mar. 6, 2017, now abandoned.
(60) Provisional application No. 62/304,026, filed on Mar. 4, 2016.

(51) Int. Cl. G06Q 40/04; H04L 9/06; G06Q 50/18; G06Q 20/36

(52) U.S. Cl. CPC G06Q 40/04; H04L 9/0637; G06Q 20/3678; G06Q 50/184; H04L 9/0643

(57) ABSTRACT

Disclosed herein is an improved distributed computer network server system that includes an enhanced computer memory system that simultaneously provides transparent access to securely-recorded data for verification while minimizing network bandwidth usage and consumed processing power. Such improved computer network may be useful in facilitating many types of unconventional networked computer functions, such as providing an electronic exchange platform that utilizes intellectual property (IP) rights of copyrightable works as currency. A network portal (e.g., website and/or mobile site) administered by the platform may facilitate sales or licensing of fractional IP rights of the works owned by the artists.

### CROSS-REFERENCE TO RELATED APPLICATIONS

This application claims priority under 35 U.S.C. § 119(e) to U.S. Provisional Patent Application Ser. No. 62/758,399 entitled “TECHNOLOGICAL IMPROVEMENTS TO NETWORKED COMPUTER SYSTEMS HAVING PARTICULARIZED COMPONENTS THAT ARE SPECIALLY PROGRAMMED TO UNCONVENTIONALLY EFFECTUATE EFFICIENT BLOCKCHAIN STORAGE” filed in the name of Stewart et al. on Nov. 9, 2018. This application further claims priority under 35 U.S.C. § 120 as a continuation-in-part of co-pending U.S. patent application Ser. No. 15/451,287 entitled “MUSIC MARKET PLATFORM” filed in the name of Stewart et al. on Mar. 6, 2017, which in turn claims priority under 35 U.S.C. § 119(e) to U.S. Provisional Patent Application Ser. No. 62/304,026 entitled “MUSIC MARKET PLATFORM” filed in the name of Stewart et al. on Mar. 4, 2016, the entirety of each of which are herein incorporated by reference.

### TECHNICAL FIELD

This disclosure generally relates to improved network infrastructure for transmission of secured digital information via wired and wireless means, and more particularly relates to interfaces specially adapted for wired and wireless communication networks between remote users and terminal devices.

### BACKGROUND

With the proliferation of computer processing systems and distributed computer networks over the past two decades, most existing industries have grown, and whole new types of industries have arisen, which increasingly rely on secure network communications between services providers, vendors and customer/users of such services. Increasingly, transactions between such entities are conducted at least in part over publicly-accessible computer networks, such as the Internet, which increases the need for secure communications and reliable data storage. Such online services providers typically provide a webpage that present a graphical user interface (GUI) for exchanging information and data. There is an inherent trust relationship established thereby, where online services providers are entrusted to maintain the data they received securely, accurately and without unauthorized alteration. But, to date, there remains no reliable means by which third parties may audit the validity of data maintained by many online services providers. This, in turn, inhibits the ability of industries that rely on a higher degree of trust and transparency regarding data integrity.

One recent attempt at providing secure and transparent data storage is blockchain-based data storage systems. Blockchain servers are typically geographically distributed and maintain redundant ledger records that are authenticated at the time of writing among the various blockchain servers such that data is written permanently, and is both publicly-accessible and unalterable over time. A blockchain ledger is inherently resistant to modification of the data defined within the transaction blocks, as each transaction block in the blockchain is cryptographically linked to the previous transaction block in the blockchain. However, blockchain data storage systems are notoriously expensive to access and maintain, due to the amount of additional processing time and power needed to properly secure data in such systems. Accordingly, while blockchain data storage systems are useful in certain instances, it remains cost-prohibitive for many services providers across various industries that could otherwise avail themselves of such functionality.

The entertainment industries, in general and the music and recording industries in particular, are currently fragmented. Major labels and publishers are predominately focused on finding the next “grand-slam” home run talent rather than promoting a wide variety of new and developing artists with no track record of prior success. Such artists have few realistic options to directly generate real income growth.

On the opposite end of the spectrum, impassioned fans who want to help their favorite artists have no real direct options to do so, other than purchasing their works (where only a small fraction of these revenues make their way to the artist) or, for the limited array of artists that have the ability as primary copyrights holders to list themselves there, potentially donating through crowd-funding systems like PATREON.

With this noted demise within the entertainment industries, there are likewise no readily available paths for new or emerging artists to access resources for career development within a fragmented and ill-defined ecosystem of resources. This has resulted in a few massively popular artists and a plethora of talented, but leaves unconnected and unsophisticated artists to post their unpolished songs on social media sites in hopes that they will be “discovered.” Artists also have limited options available to monetize their works and fund their creative endeavors. Outside of the typical record label and publishing, artists and rights holders thus have very few options for achieving liquidity or success.

Typical label and publishing deals rely on antiquated protocols that lack transparency leaving even established artists with flattened or inaccurate earnings unless they continue to release new works and/or tour. Even for artists who attempt to crowd-fund, the actual value of such efforts is mainly short-term and typically serves only as a stop-gap. There is only so much income that will be derived from the personal ‘thank you-s’ or autographed materials, which typically incentivize this type of support.

Established artists, too, see diminishing advances and an increase in rights tied up with those advances, based on current industry trends. They have become beholden to what is essentially a collateralization of virtually 100% of their creativity and future work in exchange for a tiny fraction of the value they create.

Similarly, individual songwriters often have copyrights in numerous compositions with no way to personally monetize their rights or develop new income streams, which, in turn limits their ability to continue to contribute to the creative economy.

In these multi-billion dollar entertainment industries, all of the forgoing clearly does not represent an efficient operating model. Accordingly, a need exists for technological improvements in computer systems that may be readily leveraged by many industries, including, for example, facilitating secure and reliable access by artists to career development and funding resources.

### SUMMARY

In order to facilitate secure, transparent and unalterable data storage in an improved efficient manner that reduces processing time, network bandwidth usage and power consumption, the present disclosure now introduces the following enhanced computer memory storage system that may be leveraged across many industries, including the entertainment industry, financial services, banking services, investment services, exchange trading services, currency exchange services, contract recordation services, purchase verification and fulfillment operations, cargo tracking systems, medical record storage, electronic voting systems, census recording, government records storage, and data integrity storage services. The system may include a network server system having at least one processor in operative connection with electronic memory for storing specially-programmed processing instructions and customized databases and a network communication interface for communicating processing instructions and requests between the network server system and remote computing devices over a publicly-accessible computer network, such as the Internet. The network server system may further hosting a publicly-accessible website for submitting instructions and requests there-through and presenting immediate confirmations thereon. The network server system allows remote computing devices of a plurality of users, i.e. personal computers and smartphones, visiting the website to transmit processing requests to, and responsively receive output instructions from, the network server system via the network communication interface over the Internet, the processing requests and output instructions stored in the customized databases and immediately accessible via the website thereafter. The network server system further communicates with a separately accessible blockchain distributed storage system via the network communication interface for selectively and verifiably storing output instructions generated by the network server system in response to processing requests received from the plurality of remote computing devices. Specially programmed processing instructions provides a technological improvement that enables the processor of the network server system to receive a processing request from a remote computing device via the website, store the processing request in the customized databases, determine output instructions based on the processing request received from the remote computing device, store the output instructions in the customized databases such that they are immediately verifiable by the remote computing device via the website, generate confirmation instructions by calculating at least one of a checksum value and a hash value from at least a portion of the output instructions, transmit the confirmation instructions via the network communication interface to the blockchain distributed storage system for permanent and unalterable storage, and transmit the output instructions with additional received output instructions from other users as a batch submission, at a later time than the storing of the confirmation instructions, such that consumed processing power is lower than if the output instructions and the additional output instructions were transmitted separately to the blockchain data storage system. The output instructions along with the confirmation instructions are thereafter publicly accessible via the blockchain distributed storage system for readily verifying the validity thereof.

In additional embodiments, the specially programmed processing instructions introduced herein provide further technological improvements that enables the processor of the network server system to receive, from an external data source, update instructions for updating the variable in the customized database, responsively generate updated output instructions based on the update instructions and a value of the variable, store the updated output instructions in the customized databases for immediate availability via the website, generate updated confirmation instructions by calculating at least one of a checksum value and a hash value from at least a portion of the updated output instructions, transmit the updated confirmation instructions via the network communication interface to the blockchain distributed storage system for permanent and unalterable storage on a blockchain thereof, and transmit the updated output instructions with the additional updated output instructions as a second batch submission, whereby the updated output instructions are verifiable by any remote computing device using the updated confirmation instructions.

The network server system, the remote computing devices and the blockchain distributed storage system introduced herein form, via implementation of the specially-programmed processing instructions, an improved distributed computing network that provides immediate availability of confirmation of processing requests and transparent, permanent, unalterable storage of output instructions generated from received processing requests, along with introducing abilities to provide update instructions thereto, in a manner that conserves bandwidth consumption, lowers consumed processing time and power, allows for immediate and long-term verification, and maintains trust among all parties, all at a lower cost than conventional data storage systems previously in use.

The improved distributed computing network, sometimes referred to herein as VEZT or the VEZT platform, brings cutting-edge blockchain technology to various industries, including the music industry. In such application, VEZT gives artists the power to monetize their copyrighted works, such a musical works and recordings, on a song-by-song basis, while allowing fans, investors and brands to participate in royalty-bearing song rights, and, in various embodiments, on a fractional basis. Established artists may likewise immediately monetize new copyrighted works directly from their fans. Individual songwriters and other works producers may also readily participate. VEZT lets them monetize as little as 1% of their song IP rights. Monetization may take place using a specialty cryptocurrency offered through VEZT that represents a fractional share of ownership rights in a copyrighted work, whose value may change based on actual demand and received royalty payments.

### BRIEF DESCRIPTION OF THE DRAWINGS

FIG. 1 is a block diagram of a distributed network communication system according to various embodiments of the present disclosure;

FIG. 2 is a flowchart illustrating exemplary communications between components of the system of FIG. 1, according to various embodiments of the present disclosure;

FIG. 3 is a block diagram depicting an implementation of a music market (MM) platform that offers ownership interest in the royalty-bearing rights of copyrighted works in exchange for currency in various forms, according to some embodiments of the present disclosure;

FIG. 4 is a block diagram of a computing device operable to implement the disclosed technology according to various embodiments of the present disclosure;

FIG. 5 is a flowchart of an INITIAL SONG OFFERING process according to various embodiments of the present disclosure;

FIG. 6 illustrates an artist participation process according to various embodiments of the present disclosure;

FIG. 7 illustrates a royalty accounting and distribution process according to various embodiments of the present disclosure;

FIG. 8 illustrates a song token trading process according to various embodiments of the present disclosure;

FIG. 9 is a block diagram of exemplary currency exchanges available for the INITIAL SONG OFFERING processes described herein;

FIGS. 10-12 illustrate fields of the customized databases used in various embodiments of the present disclosure;

FIG. 13 is a depiction of exemplary terms for an INITIAL SONG OFFERING according to various embodiments of the present disclosure;

FIG. 14 is an exemplary screen display of an INITIAL SONG OFFERING according to various embodiments of the present disclosure;

FIGS. 15-18 are block diagrams of blockchain components used in various embodiments of the present disclosure;

FIGS. 19-26 depict exemplary programming of blockchain functions utilized in various embodiments of the present disclosure; and

FIGS. 27-29 depict exemplary flowcharts of enhanced and improved storage processes according to the present disclosure.

### DETAILED DESCRIPTION

The purpose of terminology used herein is only for describing embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating” or the like refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

As used herein, the terms “connected,” “coupled,” or variants thereof, mean any connection or coupling, either direct or indirect, between two or more elements. The coupling or connection between the elements can be physical, logical, or a combination thereof.

As used herein, the term “entertainment industry professional” refers to a person having an occupation associated with the entertainment industries, such as the music industry, the movie industry, the television industry, the book publishing industry and the like. Non-limiting examples include agents, producers, investors, and the like.

As used herein, the term “brand” refers to an entity associated with any industry that utilizes an identifying mark to distinguish the entity from other entities associated with the industry. Examples include AT&T, TOYOTA, COKE, UNIVERSAL MUSIC GROUP (UMG), BMG RIGHTS MANAGEMENT, SONY, WARER CHAPPELL MUSIC, and KOBALT MUSIC.

As used herein, the following terms have the corresponding primary meaning, unless otherwise indicated or amended:

“Smart Contract”—a digital contract establishing rights purchased through the VEZT Platform for fractional shares of royalty ownership.

“VEZT Offering” or “INITIAL SONG OFFERING (ISO)”—VEZT Offering/ISO smart contract functions.

Offering (ISO)—The listing of intellectual property rights up for sale.

Contributor—A VEZT platform user who purchases a fractional share in royalty payments from a VEZT Offering.

Offering Contribution—a cryptocurrency-based digital transaction made for a specific offering, including all details of the transaction and the transaction state.

Application Software Layer—Internet and mobile client applications (apps) that run the VEZT web interface or application by implementing specially programmed processing instructions (software-based processing logic) for executing the functions of the VEZT platform.

Domain Software Layer—backend application programming interface (API) services and other technology that contain specially programmed processing instructions for processing VEZT platform transactions and other business requirements.

Transaction Software Layer—a backend API service layer that handles preparation, signing, and broadcasting of blockchain transactions onto a decentralized network.

Managed Funding Source—an administrative digital wallet used for the purposes of allowing fiat contributions to be converted to cryptocurrency tokens, such as VZT coins as described herein.

Personal Funding Source—A VEZT user's personal digital wallet created on the VEZT app or imported from a third party location, which is used for funding transactions on the VEZT platform.

While described primarily with respect to specific fields of use, it should be appreciated that this disclosure provides technological improvements in computer processing and networked systems by introducing and specifically describing specialized processing instructions, manipulations of customized database fields, improved graphical user interfaces, and original network and computer hardware inter-connections that result in superior performance in both transaction report times and permanent indelible data storage that have heretofore not been achieved and could not be achieved by conventional or previously existing systems. The VEZT platform utilizes cryptocurrency-like digital tokens to secure transaction details, which transactions are permanently and unalterably stored in an improved manner in a blockchain storage system. Such permanent storage is achieved efficiently while simultaneously and unconventionally allowing such transactions to be separately and immediately confirmed via custom databases that update improved graphical user interfaces that are provided to users of the platform.

In particular, it is well-known that conventional blockchain storage systems consume more electrical power in operation than other prior data storage systems, and such entry and storage of blockchain data can be correspondingly expensive. The VEZT platform, and other technological fields which may benefit from the present disclosure, must provide instant confirmation of transactions to users of the graphical user interfaces of their user devices in order to maintain participant confidence. At the same time, where thousands or more transactions may be being processed simultaneously and continuously for given periods of time, it may be expensive and energy-intensive to simply record such volume of transactions in real time in a conventional blockchain storage system. The present disclosure introduces novel programming techniques, backend data services, and original network arrangements to achieve both real-time reporting to other devices, while efficient providing reliable and permanent blockchain data storage that is separately auditable in a particular combination of hardware and software components.

While described herein primarily in terms of a platform for processing certain financial transactions and contractual rights, the technological improvements are not limited to such an environment, and may have applicability in such fields as voting systems, medical test reporting systems, equity exchanges, lottery systems, law enforcement, financial transaction systems, attendance recordation systems and any other environments in which instant report-ability and unalterable data storage are of primary need. Conventional systems have heretofore not been provided to address these simultaneous needs in a technologically improved and efficient manner.

Disclosed are methods and systems including a computing platform that facilitates access by users (e.g., artists) of the platform to resources (e.g., career development resources). This platform includes a music market (MM) server or service, also referred to herein as the VEZT platform, that establishes a marketplace for intellectual property (IP) rights to musical or other works as currency that can be exchanged for access to such resources. While certain embodiments herein will be described in detail with respect to IP rights to a music composition for use in the music industry, it is fully contemplated that the VEZT system described herein may be expanded to include audio-visual works, video works, writings, live or recorded spoken word, movies, television programming, radio broadcasts, public performances, and other forms of entertainment and expressions without limitations, which may be protected by copyright or other intellectual property rights, such as patents, trademarks, trade dress and trade secret, without limitation.

The technologies introduced herein allow the VEZT platform to be used, for example, to disrupt traditional record label and publishing environments by putting artists in control over the rights and terms to be offered on a work-by-work basis, with investment records secured in a blockchain-enabled platform. The VEZT platform empowers artists to monetize fractional interests in their master recordings and/or copyright rights. This gives fans, brands and institutional investors the opportunity to, for example, securely own a piece of their favorite songs while also receiving royalty income therefrom. The VEZT platform may share each available investment as a playlist of sorts, with both the artist's and investors' social media networks for maximum exposure and monetization on a global basis. The VEZT platform provides artists, fans, investors, entertainment professionals and brands with a transparent and equitable marketplace to easily and quickly monetize, for example, music IP, on a song-by-song basis.

The VEZT platform further gives artists full control over their rights, reversions and the initial amount they want to raise, while amplifying each transaction through both the artist's and investor's social media networks. Artists choose how much they'd like to raise from a fraction of their rights from one song (for example, $100,000 for 10% of their songwriter rights), the reversion term (3, 5, or 10 years, or in perpetuity), and set a date for the ISO. Rights-buyers on the VEZT platform (including fans, music professionals, corporate brands and other investors), buy the rights during an ISO, and the artist receives the funds credited to their account immediately.

The song rights information is encoded on a blockchain. Royalties are collected from Performing Rights Organizations (“PROs”) in over one hundred thirty-five countries around the world, as well as through organizations such as STEM, which aggregates digital performance royalties from SPOTIFY, ITUNES, YOUTUBE, PANDORA, and other online digital data streaming services.

The VEZT platform provides tracking and collection on all ownership interests through the blockchain smart contract technology introduced herein, which will allow a secure and transparent method for rights buyers to receive their royalty earnings as quickly as possible. The VEZT smart contracts handle the functions of writing to a blockchain for the purpose of storing and selling fractional portions of income streams related to intellectual property. The process we employ uses an in-memory cache to store information related to a user and ensure they have been verified and approved for transacting on our platform. The mechanism by which we achieve this process utilizes custom Application Programming Interfaces (APIs) that authenticate a user's on our platform prior to allowing access to our marketplace. We require all users to register with our web or mobile applications and by doing so, they are allowed to purchase the content on our platform. However, being that the blockchain is a public ledger, we have built safeguards into our smart contract to ensure only valid users are able to make contributions and transact on our publicly listed offerings.

The INITIAL SONG OFFERING is used to raise funds, which the artist receives in exchange for granting investors a percentage of the royalties the song receives for public performances around the world. This information is then bundled with a cryptocurrency token, sometimes referred to herein as a “VZT token,” to serve as the main data source for rights administration on the VEZT platform.

Each INITIAL SONG OFFERING may include a particular date and time when song rights will be available to the public. Just as an online ticket sale for a popular artist may sell out in minutes, an ISO creates a focal point for awareness, demand and opportunity.

The VEZT platform, in various embodiments, utilizes off-chain data sources to collect royalty information. When paying out a song's rights-holders, a royalty smart contract database is polled for information about rights-holders of a particular song. The information contained in the smart contract, along with the users' preferred method of payment is combined to payout the appropriate royalties.

The music industry as a whole is currently fragmented with the major labels experiencing a devaluation of their master recordings. This has led them to seek so-called “360” deals, taking pieces of all revenue sources an artist may possess. The VEZT platform allows labels to monetize master rights directly with their artists' fans, bringing real value back to the copyrighted masters they own. The VEZT platform also lets labels quickly and efficiently put capital to work across a vast number of songs with tremendous cost saving efficiencies. Instead of paying for, say, a dozen songs at a time (as “albums”), the VEZT platform enables labels to buy IP from new artists they see potential in, for a fraction of their traditional spend. There are several streams of income that contribute to the overall net gross profits of a music release. Unfortunately this money typically takes up to twelve month to be accounted for and distributed to the owners of IP in conventional existing manners. With the introduction of the VEZT platform, owners can take a small percentage of these rights and monetize them immediately.

Before the introduction of VEZT technology herein, it was impossible to directly buy a fractional interest in a given copyrighted work. The closest anyone could get would be to buy stock in music labels, which are typically owned by multi-faceted companies (i.e., SONY) whose values are far divorced and widely diversified from the value of individual songs themselves that they publish and distribute. After a song has hit the market and the initial release buzz has died down, music royalties have relatively predictable returns that the average consumer would have no means to tap into. The VEZT platform thus provides artists and associated IP holders with an equitable and transparent platform to easily and quickly monetize their songs. The VEZT platform allows fans, music professionals, rights-buyers and brands to partner with artists on a song-by-song basis and share directly in IP ownership. ASCAP and BMI (and other Performing Rights Organizations) each collected over $1 Billion in royalties in 2016 per their respective publicly available annual reports. Hence, even fractional rights in IP can provide lucrative returns in the marketplace enabled by VEZT technology.

VEZT functions essentially like a rights micro-publisher in that as little as 1% of a song's rights may be offered to fans and rights-buyers. This allows artists to use fractions of a song to fund the production of future works and hire the experts they need to take their music to the next level.

With respect to new artists, VEZT allows artists to choose the proportion of rights in their works to monetize, lets them set the valuation based on their liquidity needs, and provides a transparent blockchain-based architecture to track, collect, and distribute royalty income derived from these rights. This gives new artists increased control over their work by providing a clean and easy to use interface to let them decide which tracks they wish to monetize without needing to build their own individual platforms. New and emerging artists typically need financial resources to write, record, and promote their work. Music videos, partnerships, and YOUTUBE ads as heretofore predominantly used, are costly, and hiring the talent needed to effectively leverage these investments is outside of the budget of the average emerging artist. This is one of the reasons why many of today's top songs, for example, sound eerily alike. They are products of a risk-adverse industry wherein truly creative concepts rarely attract upfront capitalization from market makers that is necessary to launch properly. This becomes less of a problem when the investor base is a crowd of millions rather than three or four large entities who judge artists based on how well they fit into their quarterly-driven spreadsheets, as can be leveraged with the technology introduced herein.

With respect to established artists, such artists usually retain various rights that may not be encumbered by labels or publishers. This may include songwriter rights that are, for example, paid directly through PROs. Frequently there are master reversions and re-recording clauses that allow artists to control master rights—another type of copyright that can be instead be more efficiently monetized through the VEZT platform. Artists, performers, co-writers and even producers are able to monetize their work and see immediate liquidity to enable more creative risk and more interesting output.

Legacy artists and individual songwriters can reinvigorate their earnings and fan bases by using VEZT to market portions of songs from their back catalogs. Marketing even 10% of a single song from a decades-old album can ignite new interest in the artists, raise thousands or hundreds of thousands of dollars, and provide direct financial benefit to the fans who believe in them enough to vote with their wallet.

With respect to fans and similar potential rights-buyers, their interests in copyrighted works are typically deeply emotional. This feature of human nature, in fact, drives how filmmakers scores key motion picture scenes, how people react on the dance floor, and even how some couples maintain bonds with each other across years and distance. Owning a part of your favorite song—the song you were married to, the song that helped you get through a difficult life-experience, is much more visceral than something that provides financial gain. It speaks to what it means to be human. With VEZT-enabled technology, fans can go beyond saying they love a song—they can actually own it.

From the financial side, rights buyers can diversify their risk profiles and open the door to stable returns in a multi-billion dollar industry. IP ownership allows investors to directly participate in royalty earnings. Reversion options allow investors to continue to earn royalties on their song IP, until their investment has been recouped. Whether a fan or just someone looking to monetize musical IP, there is tremendous opportunity for all with the VEZT platform.

With respect to entertainment professionals, including industry executives, soundtrack supervisors, producers, brands, and even record labels and music publishers can benefit from VEZT. The ability to build a portfolio of IP ownership is a strong incentive to utilizing the works in such portfolios in ways that build value. Placing a song in a movie or TV commercial can result in a huge increase in royalty earnings, and would benefit all owners of that song's IP rights. Record labels can make their master rights available directly to their artist's fans, as a way to recoup their advances, and music publishers can breathe new life into older catalogs, by making their rights available directly to consumers through VEZT.

In various embodiments, the VEZT platform administers a network portal (e.g., website) that creates a pathway for new and/or emerging artists to sell or license intellectual property (IP) rights of their works in exchange for access to career development resources. Examples of career development resources include services and information that facilitate engaging with music industry professionals. For example, the VEZT platform may establish a communications link between an artist and a music industry professional by way of the network portal. The VEZT platform may also collect royalties and distribute the royalties in accordance with the sale or license of IP rights.

In some embodiments, the VEZT platform provides a real-time metric to assess a “creative value” of an artist relative to other artists. The metric may include, for example, a measure that is indicative of a popularity of an artist on a social media website. In some embodiments, the value of IP rights for sale or license via the VEZT platform may be based on the creative values of the artists that own the IP rights. As such, the VEZT platform provides pathways for artists to access career resources and democratizes the process for developing the artists in a transparent way.

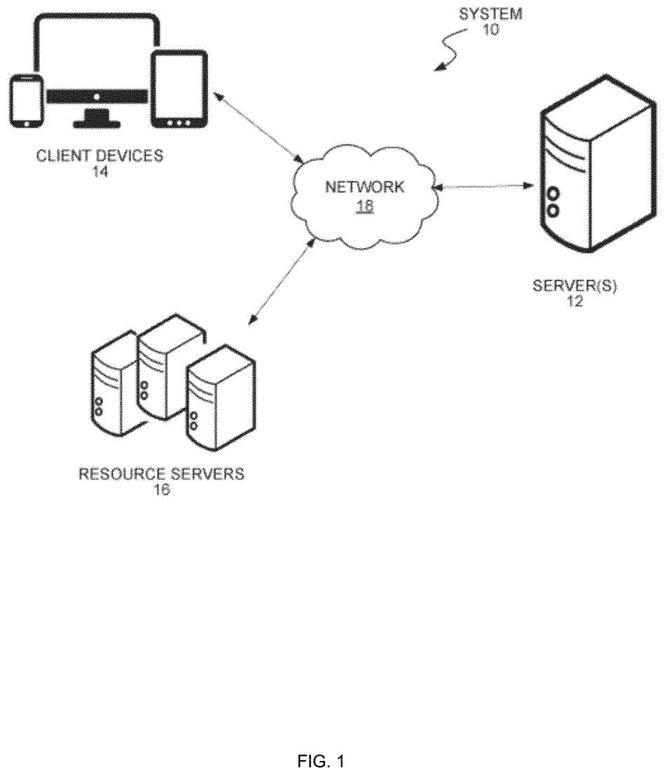

FIG. 1 is a block diagram of a system structure 10 that implements the VEZT platform according to various embodiments of the present disclosure. As shown, the system structure 10 includes components such as one or more VEZT servers 12, client devices 14, and resource servers 16, which are all interconnected over a network 18 such as the Internet to provide an intellectual property marketplace as enabled by the technological improvements described herein.

The network 18 may include any combination of private, public, wired, or wireless portions. Any data communicated over the network 18 may be encrypted or unencrypted at various locations or along different portions of the network 18. Each component of the system 10 may include combinations of improved hardware and/or specialized software to process the data, perform functions, communicate over the network 18, and the like. For example, any component of the system 10 may include a processor, memory or storage, a network transceiver, a display, operating system and application software (e.g., for providing a user interface), and the like. Other conventional components, hardware, and/or software included in the system 10 that are well known to persons skilled in the art are not shown or discussed herein for brevity.

The client devices 14 (referred to herein collectively as client devices 14 and individually as client device 14) are used by users (e.g., investors, artists, administrators and entertainment industry professionals) to interact with the system 10. Examples of client devices 14 include smartphones (e.g., APPLE IPHONE, SAMSUNG GALAXY, NOKIA LUMINA), tablet computers (e.g., APPLE IPAD, SAMSUNG NOTE, AMAZON FIRE, MICROSOFT SURFACE), computers (e.g., APPLE MACBOOK, LENOVO 440), and any other device that is capable of accessing the VEZT servers 12 over the network 18.

The VEZT servers 12 (referred to herein collectively as VEZT servers 12 and individually as VEZT server 12) may include any number of server computers that operate to transform IP rights of musical works into currency for use to facilitate access by artists to resources provided by the resource servers 16 over network 18.

In some embodiments, the VEZT servers 12 may administer a network portal (e.g., website) that is accessible by client devices 14 over network 18. For example, a website administered by the VEZT servers 12 may provide a user interface displayed on a display of client device 14. The user interface may be used to facilitate the sale or license of IP rights and/or access to resources of the resource servers 16.

In some embodiments, the VEZT servers 12 may include logic to determine a real-time metric that can be used to assess a “creative value” of an artist relative to other artists registered with the VEZT servers 12. The network portal may provide the metric and/or creative value as a score or visual representation displayed on the display of the client device 14.

In some embodiments, the VEZT servers 12 may store historical information about transactions occurring by and/or between client devices 14 being used by artists and/or entertainment industry professionals, and transactions occurring with respect to the resource servers 16 in various specialized distributed databases local to the VEZT platform. In some embodiments, the network portal may provide access to this historical information by the client devices 14. In some embodiments, the real-time metric may be based on this historical information.

The resource servers 16 may provide a variety of services and/or data accessible directly or indirectly (e.g., via the VEZT servers 12) by the client devices 14. The services and/or data are resources that artists can use to develop their careers. In some embodiments, the VEZT servers 12 may administer the services on behalf of the resource servers 16 to engage entertainment industry professionals, brands, and artists. Examples of these services include a mechanism to establish a communication link between client devices 14 being used by artists and music industry professionals.

In some embodiments, the VEZT servers 12 may collect and store the data provided by the resource servers 16, and provide that data to client devices on behalf of the resource servers 16. As such, artists using the client devices 14 can access the VEZT servers 12 to facilitate the sale or license of IP rights in exchange for access to resources provided by the resources servers 16.

Embodiments of the VEZT platform have a definite structure. For example, the VEZT platform may provide an independent service for artists to aid in developing their careers. Alternatively, the VEZT platform may supplement other services such as media players, media libraries, online radio broadcasters, mobile devices management applications, and the like. As such, the VEZT platform may operate transparently to convert IP rights of music works into currency for use by owners of the IP rights.

The structure of the VEZT platform may include various programmed components. For example, the VEZT platform may include a relative ranking system that ranks the “creative value” of artists relative to each other. The creative value of an artist may be based on prior sales or licenses of the artist's IP rights owned and may affect the value of subsequent sales or licenses of the artist's IP rights. As such, for example, artists that are ranked higher than other artists may have IP rights of relatively greater value.

The relative ranking system may determine a real-time music metric that can be used to assess the relative creative value of an artist. In some embodiments, the real-time metric may be derived from a social media “reach” measurement. The reach may reflect artist popularity based on interest from users of a social media service. In some embodiments, the real-time metric and/or creative value may be displayed as a score or graphical representation on client devices 14,which are also accessible by artists and music industry professionals. Such values may be used to determine in whole or in part, for example, spot prices for corresponding works as described later herein.

Accordingly, an artist can view his or her real-time metric compared to other artists to assess his or her creative value. Alternatively, the VEZT platform may automatically assess the relative creative value of an artist based on the real-time metric. As such, the VEZT platform can measure, analyze, and calculate values used to render assessments about artists that utilize (e.g., subscribe to) the VEZT platform.

In some embodiments, the VEZT platform may provide one or more venues for artists to connect with music industry professionals (e.g., producers) and brands (e.g., WARNER MUSIC GROUP). These venues may facilitate communications between the artists and music industry professionals. In some embodiments, the venues may facilitate access by artists to financial opportunities (e.g., investors), as detailed below.

Thus, the disclosed embodiments democratize the artist development process in a transparent way because artists, industry professionals, brands, and investors can have broad access to resources and information that create pathways for career development of the artists. In some embodiments, in contrast, access to resources and information (e.g., creative value of all or some artists) may be privileged to those with suitable access rights.

The structure of the VEZT platform may include a proprietary cryptocurrency system that enables broad accessibility by artists to resources (e.g., professional guidance) and financial opportunities. The cryptocurrency system uses IP rights (e.g., copyrights and royalties therefrom) of works as currency to facilitate the broad accessibility by artists, as described more fully herein. For example, an artist can obtain access to professional guidance from entertainment industry professionals and/or financing from entertainment industry investors in exchange for sale or license to at least a portion of the artist's copyright to a musical work. Accordingly, an artist's copyrights can effectively operate as a currency in the VEZT platform.

The cryptocurrency system may include an IP purchase and/or licensing structure to facilitate sales and/or a licensing (e.g., perpetual license or a term of days/months/years) of IP rights in exchange for access to resources. In a particular implementation, the IP purchase and/or licensing structure uses copyrighted musical works as a form of currency for users of the VEZT platform, such as a dedicated cryptocurrency token of a given value. The VEZT platform may utilize portions of the royalty revenue stream from copyrights owned by artists (e.g., up to 50% of the artist's IP) as currency in a music “marketplace” environment. For example, portions of a copyright may be sold or licensed in increments. Examples of increments include 1/100, 1/64, or ⅛ share per musical work, or any other fraction (e.g., a fraction divisible by 8, or some other useful integer). While frequently phrased herein as monetizing of copyright or IP rights, it should be understood that such monetization arises from revenue royalty streams generated from such rights, such as through sales of the copyrighted work, in all instances unless otherwise indicated.

A single musical work typically contains multiple separate copyrightable components, such as a copyright to a composition and a separate copyright to a sound recording, which can each operate as currency in the VEZT platform. The musical composition may include the music as written by a composer or lyricist. The sound recording results from the fixation of musical, spoken or other sounds into a tangible medium that can be tangibly rendered (e.g., played). The authors of a sound recording include performers and/or record producers/engineers.

Any copyrightable component or portions thereof of a musical work owned by an artist may operate as currency in the VEZT platform. For example, an artist may retain a writer's share of a copyright and sell or license a publisher's share. Because the VEZT platform can utilize portions of copyrights as currency, unfunded artists can use their musical works to readily obtain access to resources such as professional guidance and financial opportunities (e.g., access to investors) to develop their careers.

Embodiments of the IP purchase and/or licensing structure can be safe, reliable, and durable. For example, the VEZT platform may include mechanisms for registering or facilitating the registration of any transfer of IP rights in appropriate government agencies or databases. Further, the VEZT platform may include mechanisms for ensuring that artists warrant ownership to any IP rights offered for sale or licensing (i.e., as currency in the marketplace). Further yet, the VEZT platform may include mechanisms to track the exchange of IP rights between users of the VEZT platform. In some embodiments, licensing a copyrightable component rather than a sale thereof may be a more reliable and efficient way to accomplish a safe and durable structure because publishers currently rely on licensing structures.

In some embodiments, the VEZT platform may provide a questionnaire and/or template structure (e.g., templates) that facilitates creating a contract to sell or license an artist's IP. For example, the VEZT platform may administer a user interface that includes a questionnaire that presents a user (e.g., artist) with a sequence of questions (e.g., yes/no questions) that lead the user through a process to obtain information used to formulate terms of a contract. The information obtained from the questionnaire may be used to automatically populate a template for the sale or licensing of the IP rights in a manner that is transparent to the user.

For example, a “basic licensing template” may be structured for use by an artist to form a basic licensing contract. In some embodiments, the VEZT platform may automatically populate the basic licensing template with information obtained through the questionnaire, as well as any other information that is necessary to create a contract such as the subject of the IP rights (e.g., song title) and shares (i.e., portions) of the IP rights to be licensed. In some embodiments, advanced templates may include additional options in the event that there are multiple writers for a musical work, for example. As such, the questionnaire and/or template simplifies and improves the process of creating a contract for IP rights, which is otherwise complex and/or unfamiliar to users.

In some embodiments, a credible document signing platform (e.g., DOCUSIGN) could be employed to execute digital signatures and document protocols required to complete the sale and/or license of IP rights. In some embodiments, execution of a contract can be done on a work-by-work basis.

In some embodiments, all or some sales and licenses can be listed in a “Current Deals and Deal History” page (e.g., tab) of a website administered by the VEZT platform, for each artist and each entertainment industry professional. The sales and licenses may contribute to each artist's ranking metric. For example, a number of deals could increase a relative ranking of an artist compared to another artist who had fewer deals during the same time period.

In some embodiments, the VEZT platform may include a service to engage brands such as major music publishers (e.g., UMG, BMG RIGHTS MANAGEMENT, SONY, WARNER CHAPPELL MUSIC, KOBALT MUSIC) to administer (e.g., collect) artists' publishing interests worldwide, such as royalties. In some embodiments, the VEZT system may also ensure that each artist is signed to PROs as required in some territories to collect applicable performance royalties.

Accordingly, the VEZT platform immediately allows and encourages entertainment industry professionals and brands to have legitimate vested interests in a wide variety of new and/or emerging artists and provides for real engagement and collaboration with entertainment industry professionals who can contribute to an artist's endeavors and career paths. Moreover, the assistance and guidance provided by the entertainment industry professionals may result in an increase in the artist's rank in the relative ranking system, thereby increasing the value of their copyrights (i.e., currency in the VEZT platform).

Embodiments of the disclosed VEZT platform include a service for investors to invest in new and/or emerging artists. For example, a network portal administered by the VEZT platform may include a venue for investors to make financial contributions to artists. As one example, an investor can purchase a fractional portion of a copyright to an artist's musical work. The artist would then receive the payment or a portion thereof, after deducting a transaction fee, in exchange for the sale of the portion of the copyright.

Currently, persons in the position to contribute funds to new or emerging artists are reluctant because there is no legitimate path for a return on investment. The disclosed VEZT platform solves this problem by allowing any small investor (e.g., friends and family of an artist) or large investor to make a financial contribution in exchange for valuable IP rights. As such, new and/or emerging artists can more readily rely on investments from family and/or friends to launch or develop a career. Accordingly, the VEZT allows these much needed funds to be contributed to artists in exchange for valuable IP rights.

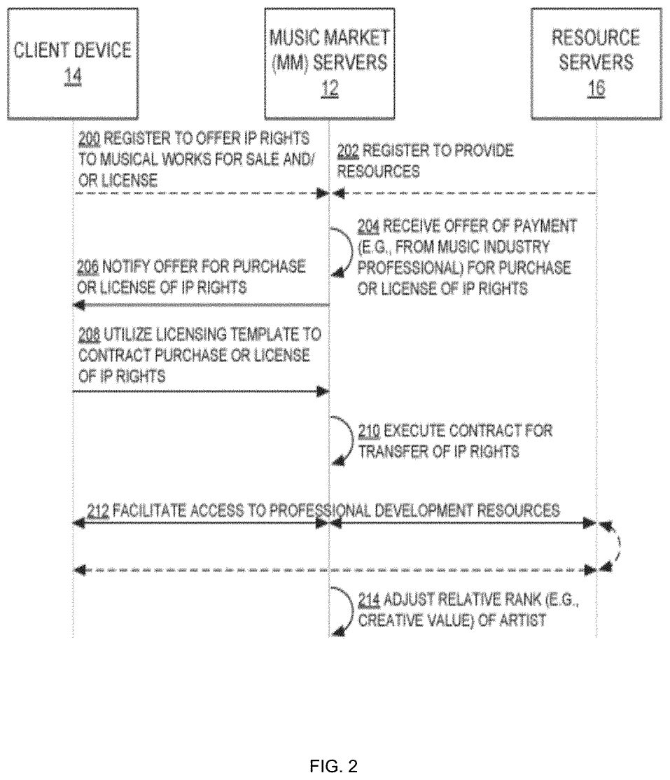

FIG. 2 is a sequence diagram that illustrates communications between components of the system of FIG. 1 according to some embodiments of the present disclosure. In step 200, an artist using a client device 14 optionally registers with the VEZT servers 12. For example, the artist may use the client device 14 to establish an account with the VEZT servers 12 and to provide a list of works and corresponding IP rights for sale and/or license. In step 202, the resource servers 16 may optionally register with the VEZT servers 12. For example, the resource servers 16 may register resources such as services or information.

In step 204, the VEZT servers 12 may receive an offer for the IP rights (or match the IP rights with an available offer). For example, the VEZT servers 12 may receive an offer from an entertainment industry professional for licensing the royalty stream generated by IP rights. In step 206, the VEZT servers 12 may notify the client device 14 about the offer to purchase or license the IP rights. In step 208, the client device 14 may be utilized to access a licensing template. The template may facilitate establishing a contract for purchase or license to the IP rights. For example, an artist using the client device 14 may input some information into a basic licensing template, and the VEZT servers 12 can automatically populate remaining portions of the template as required to complete the corresponding contract.

In step 210, the VEZT servers 12 execute the contract formed from the template by obtaining digital signatures from the licensee and licensor (i.e., artist). In some embodiments, the VEZT servers 12 may register the transfer of IP rights with the VEZT server 12 and/or an external database, and track the transfer of the IP rights. In step 212, the VEZT servers 12 facilitate access by the client device 14 to services or information of the resource servers 16. For example, the VEZT servers 12 may provide a network portal for the client device 14 to access resources. In some embodiments, the VEZT servers 12 may operate to establish a direct communications link between the resource servers 16 and the client device 14. Lastly, in step 214, the VEZT servers 12 may adjust the relative rank (e.g., creative value) of the artist based on the sale or license of the artist's IP rights in a manner similar to currency and equity markets.

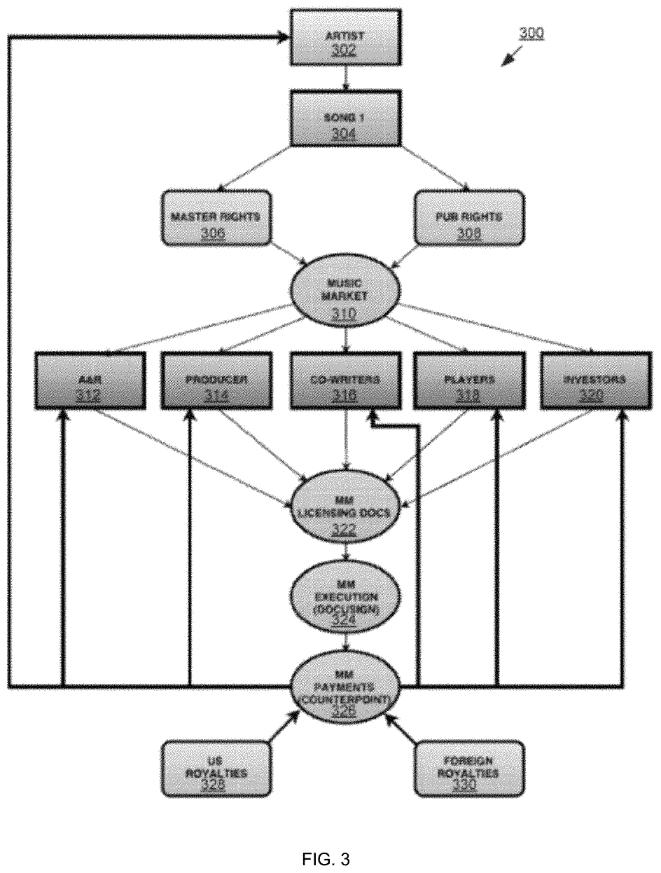

FIG. 3 is a block diagram 300 that depicts a general implementation of the VEZT platform that utilizes IP rights as currency according to various embodiments of the present disclosure. As shown, the VEZT platform facilitates management of all licenses to take place on the VEZT platform, as well as global collections from all licensees and PROs, and payments to artists and other IP owners.

In particular, the artist 302 is the owner of Song 1 (304). The Song 1 (304) has two copyright components: master rights 306 and publisher rights 308. The master rights 306 and the publisher rights 308 are administered by the VEZT platform 310. Music industry professionals, such as A&R 312, producer 314, co-writers 316, players 318, and investors 320, can access the VEZT platform 310. Each of the entertainment industry professionals can utilize the VEZT platform 310 to purchase or license the master rights 306 and/or publisher rights 308. For example, each of the entertainment industry professionals can utilize licensing documents 322 to license the master rights 306 and/or publisher rights 308.

The VEZT platform 310 facilitates execution 324 of the licensing documents 322 by utilizing services such as DOCUSIGN to execute the licensing documents 322. The VEZT platform 310 obtains payment from the music industry professionals in exchange for obtaining the master rights 306 and/or the publisher rights 308. Any subsequent U.S. royalties 328 and foreign royalties 330 are paid to the artist 302, A&R 312, producer 314, cowriters 316, players 318, and investors 320 in accordance with the executed licensing documents 322. As such, the platform provides pathways for artists to access career development resources and democratizes the process for developing the artists in a transparent way.

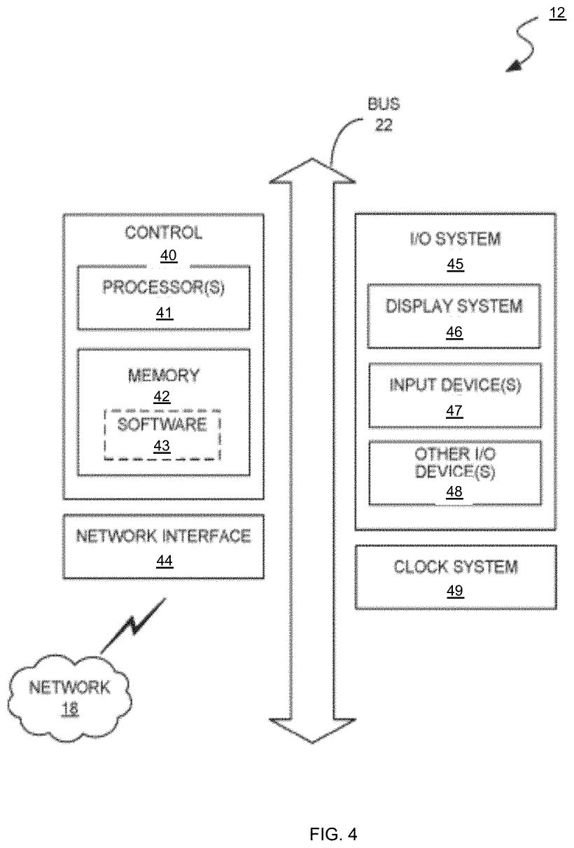

FIG. 4 is a block diagram of a server 12 of system 10 operable to implement the disclosed technology according to various embodiments of the present disclosure. The server 12 is specifically programmed to carry out features of system 10. For example, the server 12 may be a System-On-Chip (SOC), a Single-Board Computer (SBC) system, a desktop or laptop computer, a kiosk, a mainframe, a mesh of computer systems, or combinations thereof.

The server 12 may be a standalone device or part of a distributed system that spans multiple networks, locations, machines, or combinations thereof. In some embodiments, the server 12 operates as a server computer (e.g., the VEZT servers 12) or a client device (e.g., the client devices 14) in a client-server network environment, or as a peer machine in a peer-to-peer system. In some embodiments, the server 12 may perform one or more steps of the disclosed embodiments in real time, near real time, offline, by batch processing, or combinations thereof.

As shown, the server 12 includes a bus 22 operable to transfer data between hardware components. These components include a control 40 (i.e., processing system), a network interface 44, an Input/Output (I/O) system 45, and a clock system 49. The server 12 may include other conventional components not shown, nor further discussed for the sake of brevity. One having ordinary skill in the art will understand any other conventional hardware and software necessary for implementation is included but not specifically shown in FIG. 4.

The control 40 includes one or more processors 41 (e.g., Central Processing Units (CPUs), Application Specific Integrated Circuits (ASICs), and/or Field Programmable Gate Arrays (FPGAs)) and memory 42 (which may include specialized software 43 as described herein). The memory 42 may include, for example, volatile memory such as random-access memory (RAM) and/or non-volatile memory such as read-only memory (ROM). The memory 42 can be local, remote, or distributed.

A software program (e.g., software 43), when referred to as “implemented in a computer-readable storage medium,” includes computer-readable input and output instructions stored in a memory (e.g., memory 42). A processor (e.g., processor 41) is “configured to execute a software program” when at least one value associated with the software program is stored in a register that is readable by the processor. In some embodiments, routines executed to implement the disclosed embodiments may be implemented as part of conventional operating system (OS) software (e.g., MICROSOFT WINDOWS, LINUX) or a specific software application, component, program, object, module or sequence of instructions referred to as “computer programs.”

As such, the computer programs typically comprise one or more instructions set at various times in various memory devices of a computer (e.g., server 12) and which, when read and executed by at least one processor (e.g., processor 41), cause the computer to perform operations to execute features involving the various aspects of the disclosure embodiments. In some embodiments, a carrier containing the aforementioned computer program product is provided. The carrier is one of an electronic signal, an optical signal, a radio signal, or a non-transitory computer-readable storage medium (e.g., the memory 42).

The network interface 44 may include a modem or other interfaces (not shown) for coupling the server 12 to other computers over the network 18. The I/O system 45 may operate to control various I/O devices including peripheral devices such as a display system 46 (e.g., a monitor or touch-sensitive display) and one or more input devices 47 (e.g., a keyboard and/or pointing device). Other I/O devices 48 may include, for example, a disk drive, printer, scanner, or the like. Lastly, the clock system 49 controls a timer for use by the disclosed embodiments.

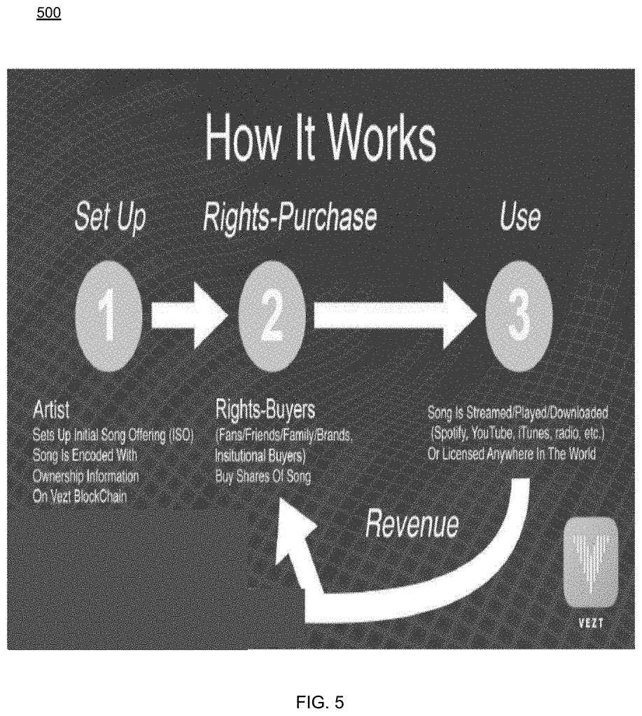

Turning now to FIG. 5, therein is depicted a flowchart of a general INITIAL SONG OFFERING process according to various embodiments of the present disclosure. As shown therein, artists set up an INITIAL SONG OFFERING through the VEZT platform, which allows them to set the amount they would like to raise from a fraction of their IP rights, including the reversion term (e.g., 3, 5, 10 year terms, or in perpetuity), and the dates for the ISO to start and end. Rights-buyers buy rights during the ISO and the artist receives these funds credited to their account.

The rights information is encoded on the VEZT blockchain and updated as royalty statuses change in a transparent manner that can be viewed through the VEZT platform or through the blockchain as a whole via a blockchain explorer.

The VEZT platform then registers the rights and collects the royalties from PROs directly on behalf of rights-buyers and deposits royalty payments into their accounts. Some key features of the platform include: (i) fractional song monetization for artists through INITIAL SONG OFFERINGS, (ii) social media sharing of both artist and rights-buyers' activity and playlists, (iii) royalty tracking and collection in more than one hundred thirty-five countries around the world, (iv) track discovery (both through the VEZT app and through exploring the blockchain directly), and (v) more efficient and transparent royalty tracking and collection encourages further investment and support of artists, all resulting in a self-sustaining system for applying patronage to the arts.

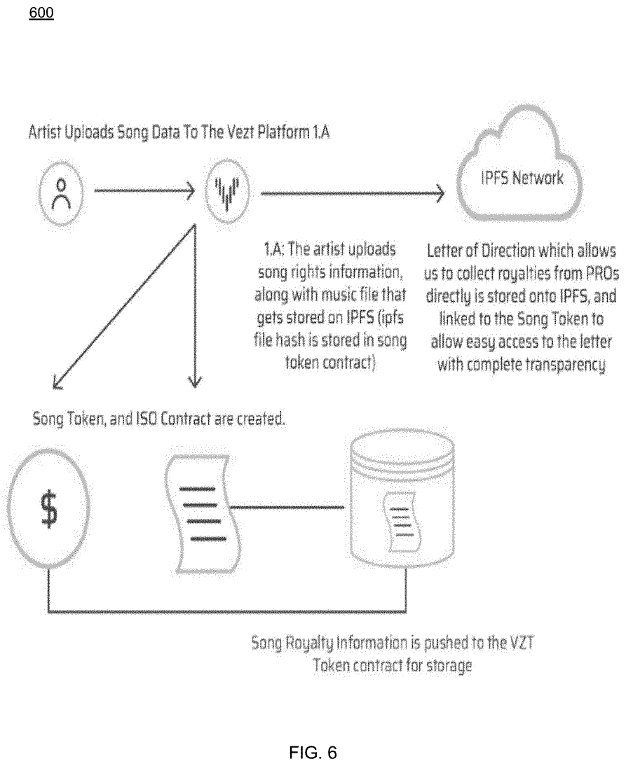

Turning now to FIG. 6, therein is depicted an artist participation process according to various embodiments of the present disclosure. When an artist registers a song with VEZT, they upload a copy of the song data to the VEZT platform along with the rights they wish to sell. They also complete a digital Letter of Direction, which allows VEZT to collect that portion of the song IP that the rights buyers purchase. Song data is used to maintain an encrypted hash of the digital signature of the song for future tracking efforts and integration with anti-piracy tools.

To provide extra protection and build in redundancy, the song and the rights information are preferably stored in a peer-to-peer enterprise storage system, such as the InterPlanetary File System (IPFS), and a global set of VEZT-owned IPFS nodes. Along with song details, the file locations of both items are used to generate two contracts: The first type is referred to herein as a Song Token Contract, wherein a VZT token is used as a means of interacting with, and purchasing individual Song Tokens (dedicated song-specific tokens that can also be sold in exchange for VZT tokens). The price of VZT in the system is a floating price based on the latest averaged VZT token price across the cryptocurrency market and according to predominant exchanges. When purchasing, or selling song tokens this price is taken into account. That way, each transaction is using the latest price average when users execute transactions on the platform. All of this will be facilitated through the use of a customized ORACLE database system as described variously herein. Additionally the VZT song token directly stores the Letter of Direction, which entitles VEZT to collect royalties and transparently provides rights-buyers with the knowledge that their fractional song ownership has the legal mechanism to allow for collection of their royalties.

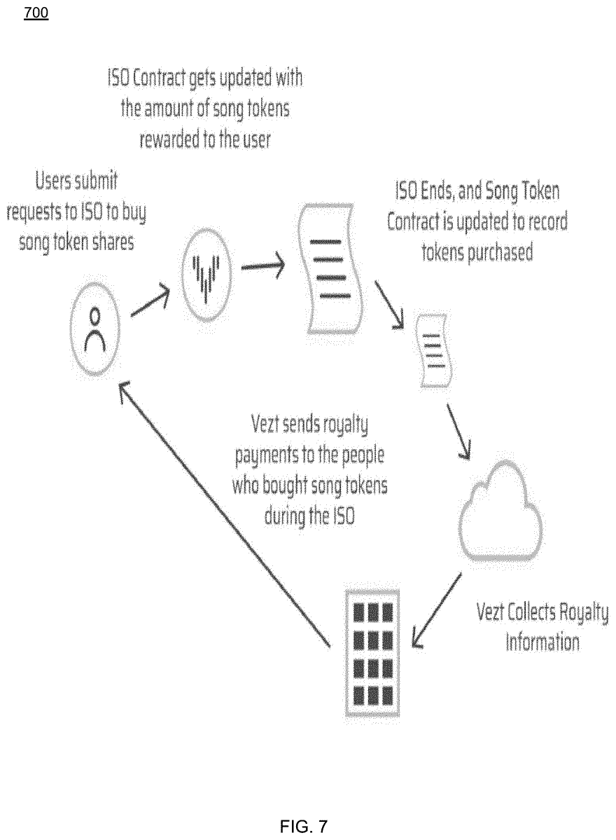

Turning now to FIG. 7, therein is depicted a royalty accounting and distribution process according to various embodiments of the present disclosure, where users submit requests to by song token shares on offer in exchange for VZT tokens of suitable value, the song tokens then being awarded to the user, song tokens are recorded, royalty information is collected and VEZT later sends royalty payments as appropriate to user's holding corresponding Song Tokens. The second type of contract referenced in the foregoing is called an INITIAL SONG OFFERING (ISO). The ISO is used to raise funds that the artist receives in exchange for granting investors a percentage of the royalties the song will receive. This information is then bundled with the VZT token to serve as the main data source.

The VEZT platform uses off-chain data sources to collect royalty information. When the time comes to pay out a song's rights-holders, specialized User and Transaction Databases shown later below are polled for information about rights-holders of a particular song token. The information contained in that smart contract, along with the users' preferred method of payment is combined to payout the appropriate royalties.

VZT tokens are able to be transparently explored through the blockchain, but the wallet in which they are stored is a semi-anonymous wallet that allows the VEZT platform to associate the owner of the token with the payment information of the associated user. Industry standard encryption using SCRYPT is a means to store the users' wallets securely. Each wallet is also secured locally on the respective user's device with secure storage encryption native on each device's software platform (i.e., KEYCHAIN for APPLE devices and KEYSTORE for ANDROID devices). Even though users can make transactions on any network that is connected to ETHEREUM, for example, the VEZT platform has its own network that offers a gateway to ETHEREUM as well. TOSHI, CIPHER, TRUST and METAMASK all utilize similar mechanics, by connecting to a third party host. Crucially, the VEZT platform may not store user private keys or wallet passwords on its servers. Instead the users are managing them on their own phone for privacy and security purposes. Not all rights-buyers will want to be paid in a cryptocurrency, and as such the VEZT platform will need to store recent address information, direct deposit information, and other personal information that is only loosely tied to the blockchain due to the manner by which a wallet is associated with a user.

The structure of the VZT token and individual Song Tokens may be based on a standard ERC-20 token which have been specially modified to include the following conventional and improved method-related functions, where the specific wording of the function is followed by a clarification of what it does, in [brackets]”
1. totalSupply( ) public view returns (uint256 totalSupply) [Get the total token supply]
2. balanceOf(address_owner) public view returns (uint256 balance) [Get the account balance of another account with address_owner]
3. transfer(address_to, uint256_value) public returns (bool success) [Send_value amount of tokens to address_to]
4. transferFrom(address_from, address_to, uint256_value) public returns (bool success)[Send_value amount of tokens from address_from to address_to]
5. approve(address_spender, uint256_value) public returns (bool success) [Allow_spender to withdraw from your account, multiple times, up to the_value amount. If this function is called again it overwrites the current allowance with_value]
6. allowance(address_owner, address_spender) public view returns (uint256 remaining) [Returns the amount which_spender is still allowed to withdraw from_owner]

Events Format:
7. Transfer(address indexed_from, address indexed_to, uint256_value). [Triggered when tokens are transferred.]
8. Approval(address indexed_owner, address indexed_spender, uint256_value)[Triggered whenever approve(address_spender, uint256_value) is called.]

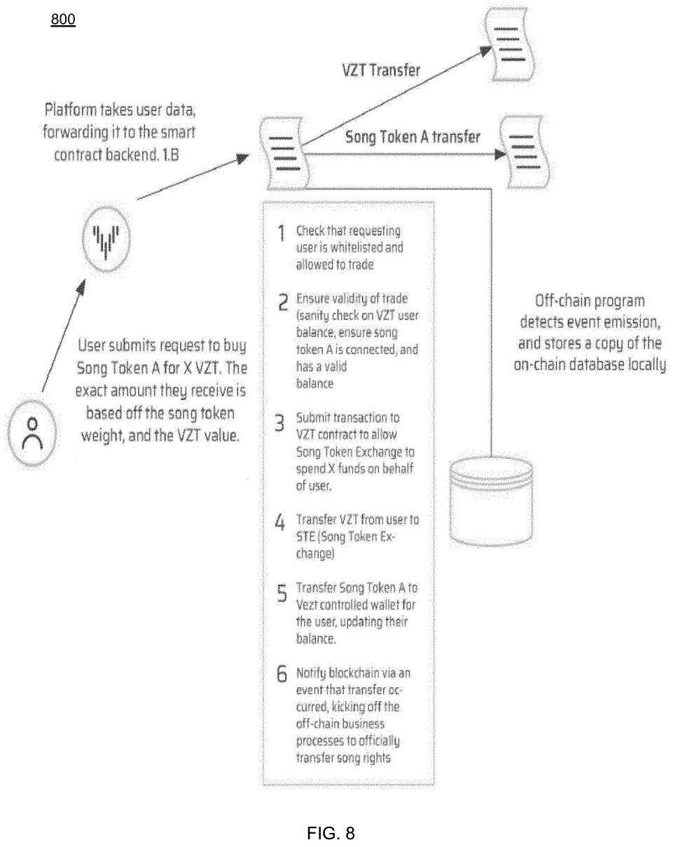

Turning now to FIG. 8, therein is depicted a song token trading process according to various embodiments of the present disclosure. As a Secondary Market for Song IP, the VEZT platform will allow for a secondary market of song IP, for those that wish to sell their acquired song IP on the VEZT platform. In order to maintain the security of users while also acknowledging and bending to the realities of the average consumer, the VEZT platform handles this through a “mostly transparent” blockchain architecture that critically relies on the VZT token.

Song Tokens act as a value transacting medium with a programming improvement that allows interchanging of rights between users on the VEZT platform, while preserving, for example, the associated royalty payment information. Song Tokens may be referred to in a different manner for types of works other than songs that may be put on offer through the VEZT platform. This process is secured by requiring Song Tokens to only be traded within the VEZT platform itself. Despite being individual tokens on their own, Song Tokens will only be exchangeable for VZT tokens, but will not be released to a user's public wallet.

According to the general depicted process, a VEZT platform user submits a request to buy a particular Song Token in exchange for VZT tokens at a present value, which may fluctuate with the value of VZT tokens on the open cryptocurrency market, or spot market. The VEZT platform is programmed to responsively receive user data and forward it to a custom User and Transaction databases as described herein. Upon completion of the digital contract, a VZT transfer from the user's wallet occurs in line with a purchase. The available VZT tokens may be exchanged to purchase Song Tokens representing fractional ownership rights to the royalties in a given work. This transactional information is stored in a custom database backend on VEZT servers 12 for providing immediate confirmation to VEZT users and administrators. Advantageously, this data is uploaded to a blockchain storage in batch with other data submissions at predetermined times or upon specially programmed processing instructions regarding predetermined conditions, as described herein.

In completing a contract, the VEZT platform is specially programmed to perform the following with respect to each user transaction. (1) check that a user is valid and allowed to participate in ISOs; (2) ensure validity of the conditions of each requested trade; (3) submit the transaction to a Song Token Exchange maintained by the VEZT platform to initiate a trade of the Song Token; (4) transfer appropriate VZT tokens to complete the trade; (5) transfer Song Token to the VEZT-controlled user wallet, which is immediately available for viewing on the user's device 14; and (6) notify the blockchain system that the transfer occurred via a hashed transaction data value, while the entire transaction is batched for later submission in total to the blockchain storage system.

While it may be desirable to be able to allow full public wallet ownership of Song Tokens, the advent of systems such as ETHERDELTA means that sold tokens would be unable to be linked directly to the entities to whom royalties are owed. Unlike the PROs themselves, the VEZT platform will not hold user balances for long periods of time and will maintain database record centralization in order to pay rights-buyers in an efficient and secure manner.

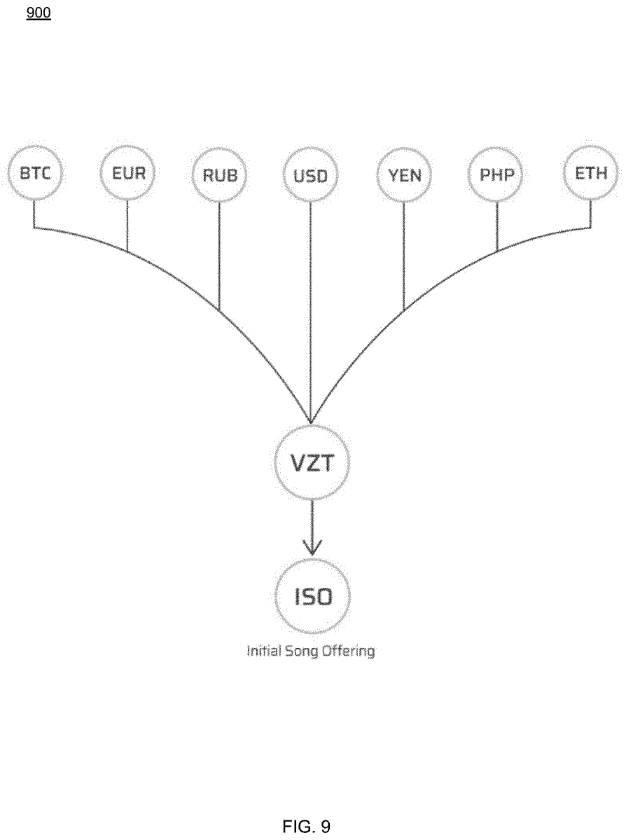

A currency agnostic investment mechanism ensures the utility aspect of the VZT token. Artists will be paid for their ownership sales in the currency of their preference and rights-buyers may fund their purchases in the ISO through their respective currency of preference. VEZT may charge a 5% fee for transactions on our platform that do not directly use VZT, to cover payment processing fees and operational margins. FIG. 9 is a graphic depicting this process on the ISO side, where various stated actual currencies and cryptocurrencies (BITCOIN, ETHEREUM, Euros, Rubles, US Dollars, Japanese Yen) and that may be accepted for VZT token purchase, which list may be expanded as the market demands.

In line with securities regulations in various countries, a token smart contract includes a “FreezeTokenTransfers” function which allows us to pause trading activity on VZT at the request of a regulatory body or in the event of an emergency.

A catalog of works from artists are available for investment via the VEZT platform. We reserve the right to modify the manner by which we open up the fractional ownership purchase of these titles for PR, market/product testing, and technical reasons, but have obtained Letters of Direction for these tracks and said Letters will be stored in IPFS alongside the track details as per every other ISO on the VEZT system.

There are many things that VEZT will do to keep onboarding new songs and IP so there are always new song IP opportunities on the platform:

Music Community Outreach—The VEZT team has decades of experience in the music industry's trenches: A&R, management, production, etc. Every day, we engage in outreach and conversations with the music community (e.g., artists, songwriters, managers, producers, and attorneys) about new opportunities to earn income with their rights;

Marketing and Publicity—VEZT executes marketing outreach and publicity campaigns to broaden its reach and scope. Trade press, industry press, and mainstream media are all included in that vision;

Partnership Opportunities—VEZT pursues partnership opportunities with similarly aligned businesses as well as create event opportunities with various promotional partners. For instance, VEZT signed a partnership/sponsorship agreement in October 2017 to provide entertainment for events at all Style Fashion Week events in more than 28 locations globally, through the 2018 season; and

Word of Mouth—Finally, the power of word of mouth cannot be discounted as a promotional vehicle. The music community, in particular, is tightly knit. Once an artist makes a significant amount of money sharing ownership of songs with their fans, word will quickly spread among artists and the VEZT platform will experience increased demand.

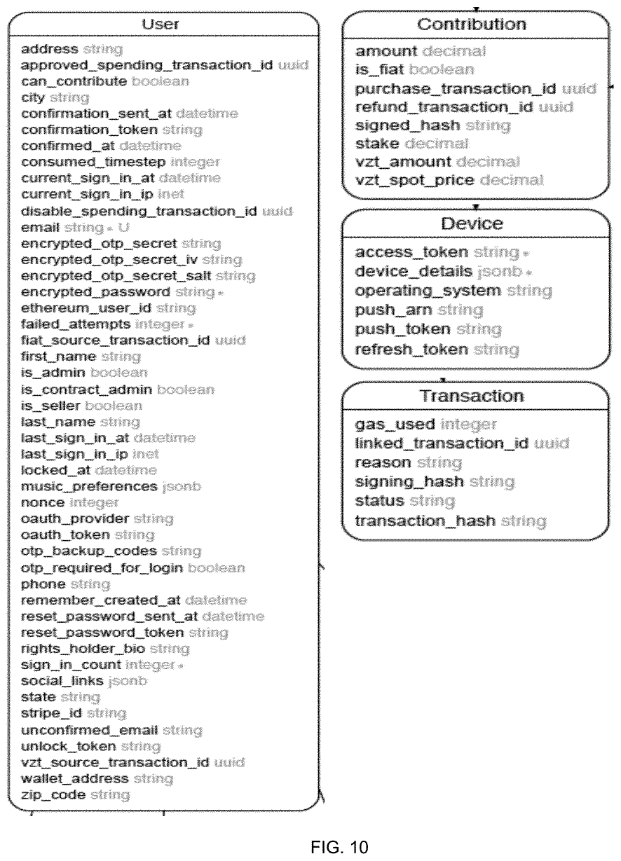

Turning now to FIGS. 10-12, therein are depicted various customized databases including data fields that may be enhanced and manipulated according to the specialized programming instructions and process flows disclosed herein. FIG. 10 shows custom databases used by the VEZT platform including a User Database, a Contribution Database a User Device Database and a Transaction database. The User Database may contain at least the following exemplary fields containing corresponding data for each registered user that is manipulated and field enhanced in specially-programmed manners by the VEZT platform: residential address, unique user identifier, contributor status, sign-in IP address, encrypted secret salt string assigned, failed sign-in attempts register, user contact information, user password, and user wallet address. The Contribution Database likewise may contain the following exemplary fields for tracking transactions: user contribution amount, user purchase transaction identifiers, user refund transaction identifiers, signed transaction hash value, cryptocurrency amount purchased, and cryptocurrency spot price. The User Device Database may likewise contain the following exemplary fields for establishing each user's valid data communication device: access token assigned, device details, operating system used. The Transaction Database may likewise contain the following exemplary fields for tracking all transactions on the VEZT platform: unique transaction identifier, signing hash value, transaction status and transaction hash value.

FIG. 11 shows further custom databases used by the VEZT platform including a Vezt Offering Database, an Initial Song Offering Database and an Offering Waitlist Database. The VEZT Offering Database may contain at least the following exemplary fields containing corresponding data for all VEZT rights offering that is manipulated and field enhanced in specially-programmed manners by the VEZT platform: unique offering identifier, offering name, offering artist, monetary funding goal, launch date, end date, publisher information, reversion period for rights offered, royalty rights type, royalty statement, and current offer status. The Initial Song Offering Database may likewise contain at least the following exemplary fields for tracking particular details of each INITIAL SONG OFFERING presented on the VEZT platform: artist name, album name, text description, funding goal, reversion period, rights holder, rights type, song name, total rights sold and purchaser identifiers. The Offering Waitlist database may likewise contain at least the following exemplary fields for tracking INITIAL SONG OFFERINGS that are not yet available: artist name, funding goal, reversion period, rights holder information, rights offered, rights type, royalty statement song title, and offering period.

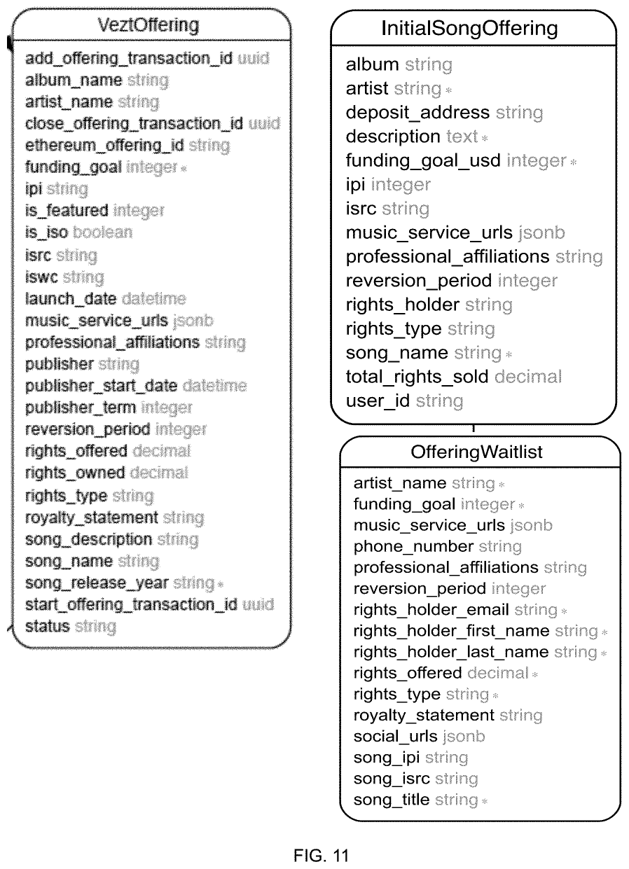

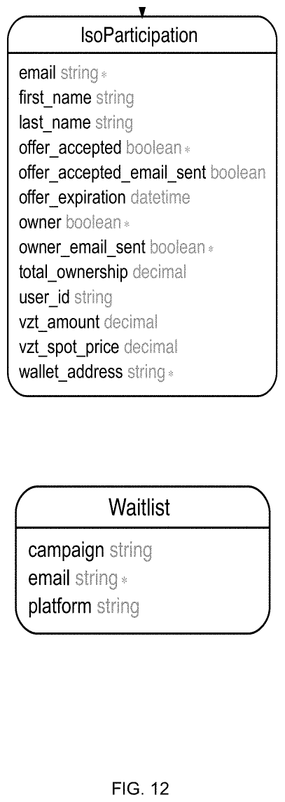

FIG. 12 shows additional custom databases used by the VEZT platform including an ISO Participation Database and a Waitlist Database. The ISO Participation Database may contain at least the following exemplary fields containing corresponding data for all participants of rights offerings, which is manipulated and field enhanced in specially-programmed manners by the VEZT platform: user email address, user name, offer accepted, offer expiration, total ownership, cryptocurrency amount, cryptocurrency sport price and user wallet address. Relevant portions of the foregoing database contents may be securely and immutably recorded as their values are continuously updated by the VEZT platform using batch transmissions to a publicly-accessible blockchain storage system as described herein.

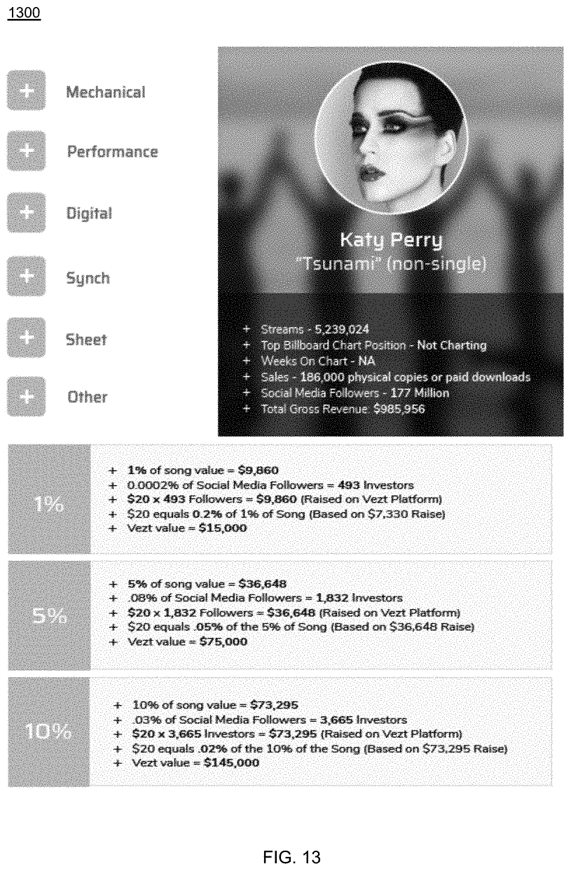

Turning now to FIG. 13, therein is depicted exemplary terms for an INITIAL SONG OFFERING term sheet1300 as may be presented to artists for display on a user device 14 according to various embodiments of the present disclosure. There are several streams of income that contribute to the overall net gross profits of a music release. Unfortunately this money may typically take up to twelve month to be accounted for and distributed to the owners of IP in prior conventional systems. With the technological improvements provided by the VEZT platform, artists can take a small percentage of these rights and monetize them. VEZT lets them monetize as little as 1% of their IP rights. There may be at least four sources of revenue distributed via the VEZT platform: transaction fees, service fees on royalty income, subscriber fees and enterprise user surcharges.

The term sheet 1300 may include a song or other work on offer, as well as the mechanical, performance, digital, synch, sheet music and other copyright rights associated with the work. The term sheet shows proposed raise amounts based on offerings of, for example, 1%, 5% or 10% of the royalties for the rights on offer.

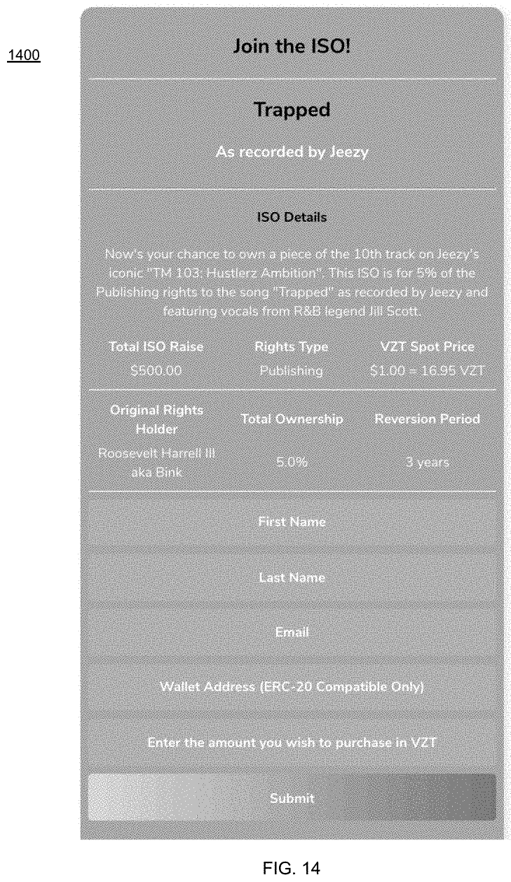

Turning now to FIG. 14, therein is depicted an exemplary improved graphical user interface regarding an INITIAL SONG OFFERING as may be presented to potential investors on displays of user device 14 according to various embodiments of the present disclosure. The display may include a description of the song or other work on offer, the available rights types and the cost for Song Tokens relating to such rights in terms of present VZT value. The investor may enter their name, email address, digital wallet address and the amount of VZT they wish to invest in this offer. Such information is used to validate the user in a secure manner and to initiate the Song Token purchase transactions required as described herein.

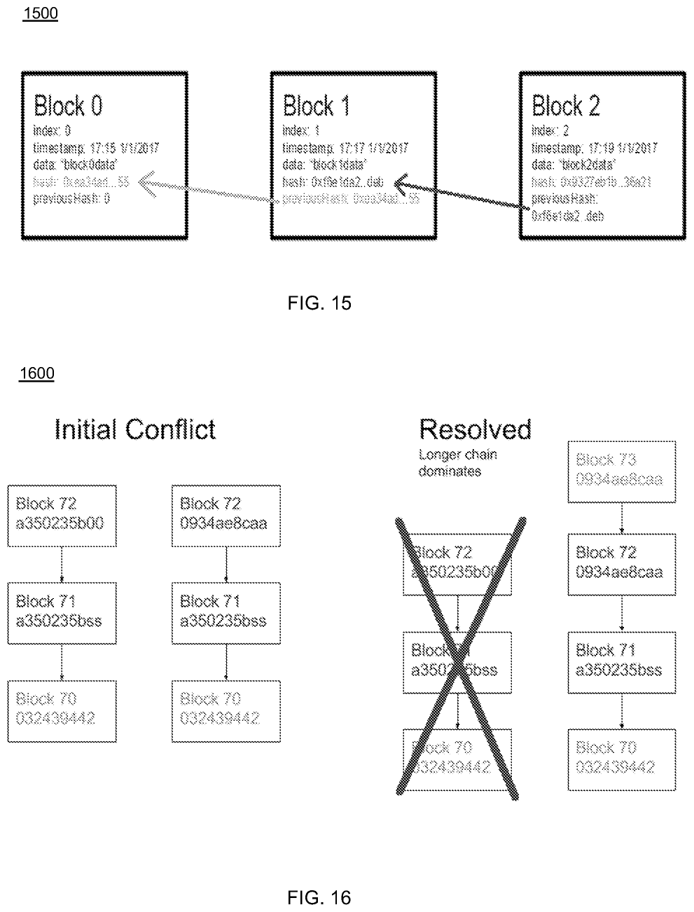

Turning now to FIGS. 15-18, therein are depicted block diagrams of blockchain components used in various embodiments of the present disclosure. The basic concept of blockchain is quite straightforward: a distributed database that maintains a continuously growing list of ordered records. However, it is easy to get mixed up as usually when we talk about blockchains we also talk about the problems we are trying to solve with them. This is the case in the popular blockchain-based projects such as BITCOIN and ETHEREUM. The first logical step is to decide the block structure. To keep things as simple as possible we include only the most necessary: index, timestamp, data, hash and previous hash. The hash of the previous block must be found in the block to preserve the chain integrity. FIG. 15 shows exemplary code 1500 for defining block structures in a blockchain environment. Each block may typically include a block index value, a date and time stamp, a data value to be recorded, a hash value corresponding to the data and a hash value of the immediately previous block. This structure maintains the integrity and renders unalterable the records stored in such a blockchain environment.

Turning to FIG. 16, there is depicted a manner of blockchain conflict resolution process 1600 prior to permanent storage. There must always be only one explicit set of blocks in the chain at a given time. In case of any discovered conflicts (e.g. two nodes separately generate a block number 72), the blockchain system will choose the chain that has the longest number of blocks. FIG. 16 thus pictorially shows how blockchain code provides for conflict resolution in this manner.

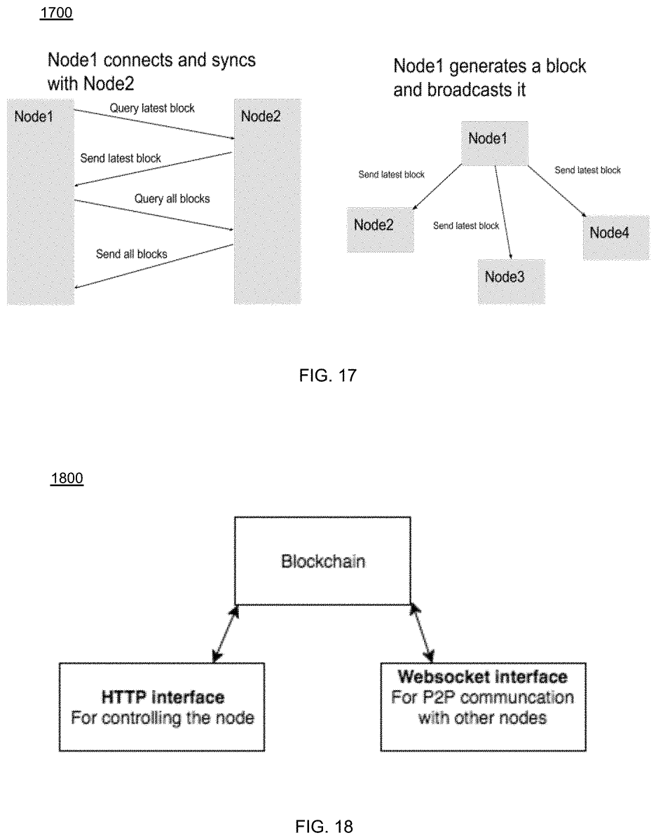

Turning now to FIG. 17, therein is depicted an exemplary blockchain node connection and broadcast process 1700. An essential part of a blockchain node is to share and sync the blocks of data with other nodes. The following rules are used to keep the network in sync.
When a node generates a new block, it broadcasts it to the network
When a node connects to a new peer it queries for the latest block
When a node encounters a block that has an index larger than the current known block, it either adds the block in its current chain or queries for the full blockchain.

No automatic peer discovery is used. The location (i.e., URLs) of peers must always be manually added for security purposes.

Turning now to FIG. 18, therein is depicted custom network structure 1800 for moderating data efficiently with the blockchain data storage system. It should be noted that the node actually exposes two web servers: One for the user to control the node (HTTP server) and one for the peer-to-peer communication between the nodes (Websocket HTTP server). This accomplishes data transfer to the blockchain in a less expensive, less power intensive, more bandwidth efficient manner than conventional systems.

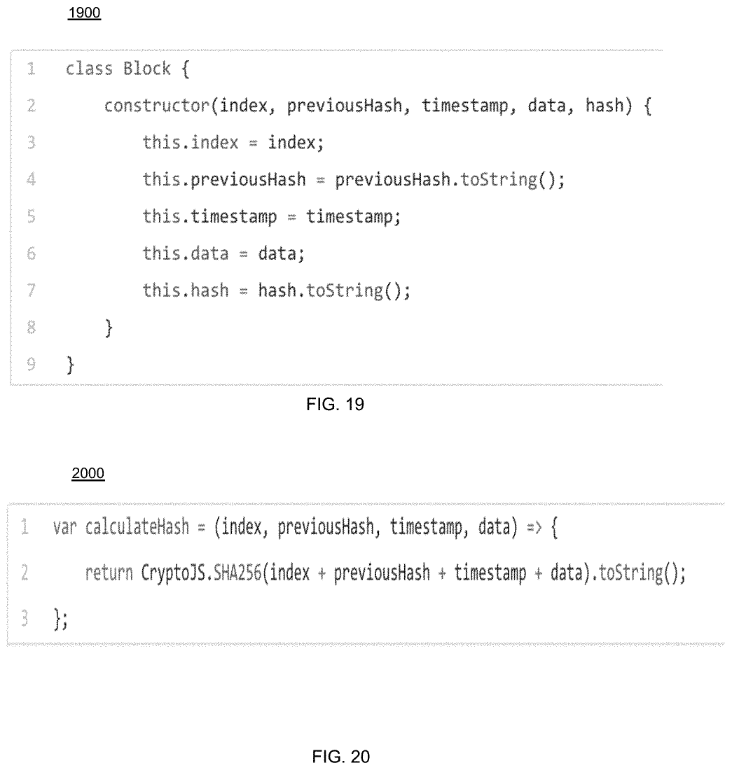

FIGS. 19-26 depict exemplary programming of blockchain functions utilized in various embodiments of the present disclosure. FIG. 19 shows exemplary code 1900 for defining a block structure in a blockchain environment.

FIG. 20 shows exemplary code 2000 for hashing a block. Each block needs to be hashed to maintain the integrity of the data. To accomplish this, a SHA-256 hash or other secured hashing method of sufficient integrity may be taken over the content of the block.

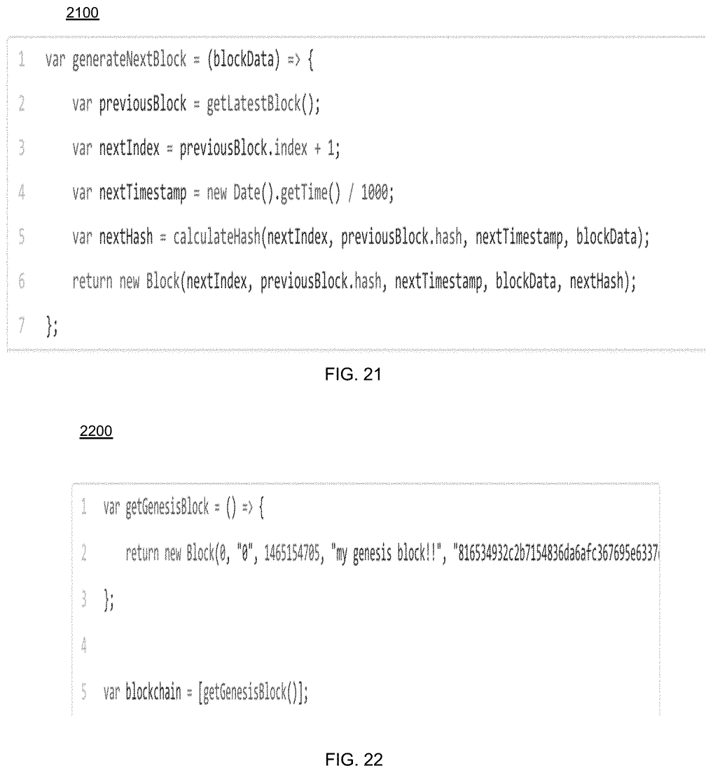

FIG. 21 shows exemplary code 2100 for generating a block in the blockchain. To generate a block, hash of the previous block is used along with current data to create the rest of the required block content (=index, hash, data and timestamp). Block data is something that is provided by the VEZT platform.

FIG. 22 shows exemplary code 2200 for storing a block. An in-memory JAVASCRIPT array may be used to store the block in the blockchain. The first block of the blockchain is always a so-called “genesis-block,” which must be hard-coded ab initio.

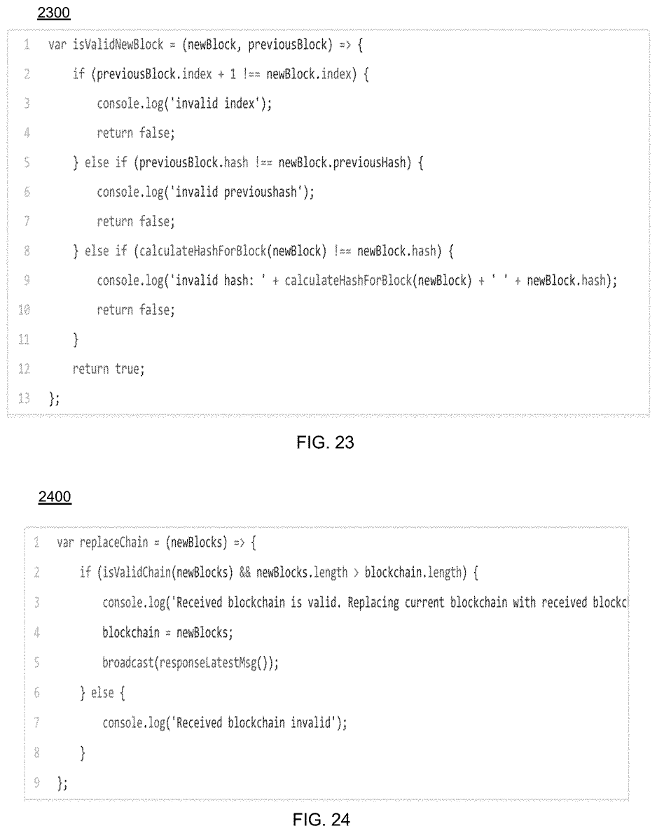

FIGS. 23 and 24 show exemplary code 2300 and 2400, respectively, for validating a block. At any given time we must be able to validate if a block or a chain of blocks are valid in terms of integrity. This is true especially when we receive new blocks from other nodes and must decide whether to accept them or not.

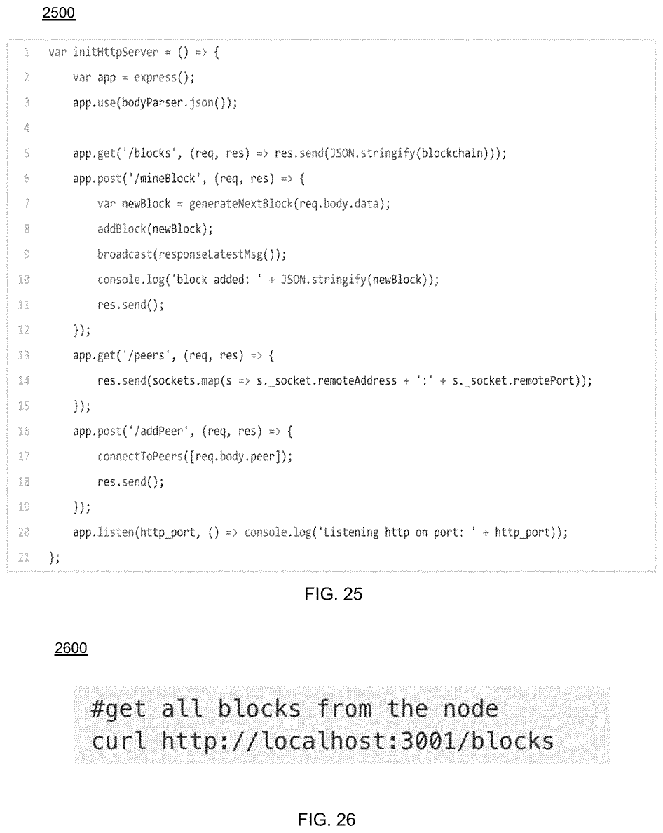

FIG. 25 displays exemplary code 2500 for controlling a node in the blockchain data storage system. As seen therein, an administrator or like user is able to interact with the node in the following ways: List all blocks, Create a new block with a content given by the user; and List or Add Peer Nodes. The most straightforward way to control the node is with, for example, CURL, exemplary code 2600 for which is shown in FIG. 26.

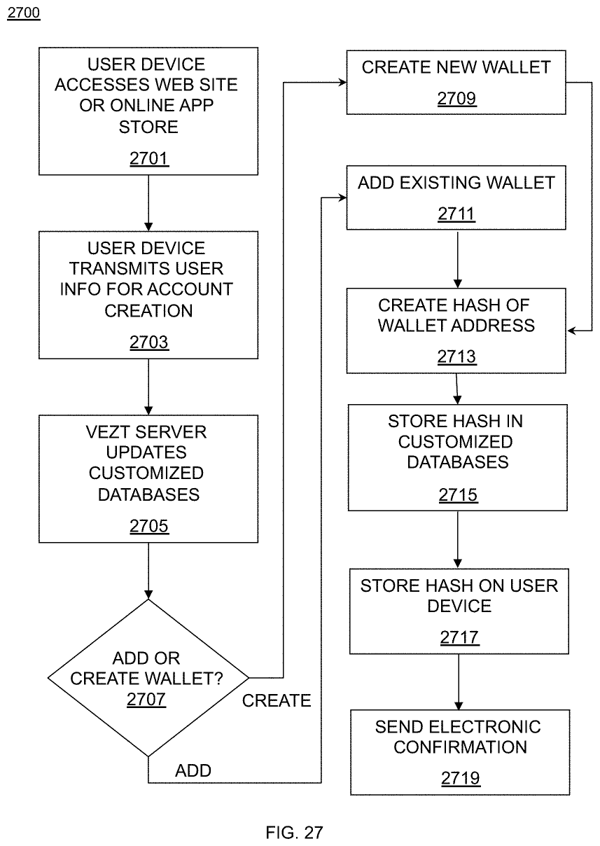

FIGS. 27-29 depict exemplary flowcharts of enhanced and improved storage processes according to the present disclosure. Turning to FIG. 27, therein is depicted an exemplary user registration process 2700 according to various embodiments of the present disclosure. The process 2700 commences when a user device 14 accesses the VEZT platform via the Web or through the app on a mobile device (step 2701). The user transmits user info for account creation (step 2703) The VEZT server 12 updates the local customized databases only (not the blockchain) with the user data (step 2705). Next, at step 2707, it is determined whether the user will add an existing digital wallet to their account or to create a new digital wallet. If the wallet is to be created the process 2700 continues to step 2709 where a new wallet is created and stored in the customized User Database of FIG. 10, while if it is to be added, the process 2700 instead continues to step 2713 below. At step 2711, the existing wallet is received from the user device 14 by the VEZT platform and stored in the customized User database of FIG. 10. Next, at step 2713, a hash is created of the wallet address value for secured storage on the VEZT platform. The hash value is stored in the custom User Database of FIG. 10 (step 2715). The hash value is then sent to the user device for storage thereon (step 2717), as may be used to automatically validate all future transactions with the user. Finally, at step 2718, a confirmation of valid account creation is sent from the VEZT platform to the user device 14, such as an email, text message or other electronic message format, after which the process 2700 ends with respect to this user. It should be appreciated that this process 2700 operates continuously and in parallel for accommodating hundreds or thousands of new users at a time.

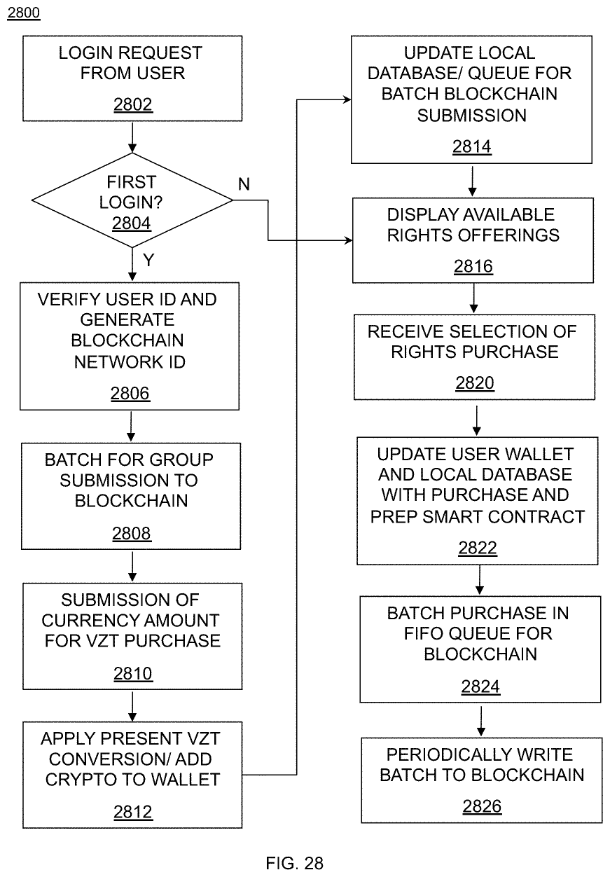

Turning to FIG. 28, therein is depicted an exemplary ISO Order Fulfillment process 2800 according to various embodiments of the present disclosure. Commencing at step 2802, a user login request is received by the VEZT platform. The platform confirms whether this is the first login request by this user (step 2804). If yes, the process 2800 continues to step 2806, and otherwise proceeds to step 2816 below. In order to ensure users are registered users on the platform, the VEZT platform must ensure that the source of the transaction is from that of an approved address that has been verified through the smart contract and its centralized backend. We ensure that the offering being sold through the VEZT marketplace can only be accessed via our application software layer. At step 2806, the platform verifies the user ID entered at login against the User Database above, and when valid generates a corresponding unique blockchain network ID. During a user's first transaction on the marketplace, an API request is made to log the user's unique ID as a verified user on the network. This is done via a secure key and a blockchain network specific identifier that is generated on our system. This unique ID and key are stored securely and made available to our transaction software layer, which then prepares transactions for broadcast on the blockchain network. This is stored as an in-memory value that allows the transaction layer to quickly verify a user's ability to participate in an offering, and verifies the user's registered device. Every subsequent transaction a user makes thru the registered device will be verified until the user's access to perform is revoked or expired by an administrator. The new blockchain network ID is registered locally in the platform and queued for batch submission with other like data to the blockchain storage data system (step 2808). Next, the user submits a currency amount for VZT token purchase (step 2810). Any currencies as shown in FIG. 9 may be used for such transaction, as well as additional available currencies. The VEZT platform applies the current VZT conversion rate from the cryptocurrency and currency spot markets (such as FOREX) to determine how much in VZT tokens is purchased for the applied currency and add this VZT balance to the user's digital wallet (step 2812). The VEZT platform then updates the local User and Transaction Databases of FIG. 10 with this VZT transaction and queues for later batch submission to the blockchain storage system (step 2814) In addition thereto, a subset of the data, such as a meta-data description of identifying portions of the transaction may be immediately written to the blockchain for later cross-verification when the full transaction data is saved to the blockchain in later batch transaction. To this end, the metadata may be hashed in whole or in part and the hash value may be matched to the later batch transaction data as submitted. Software comparison and safeguard procedures may be put in place to identify errors between locally stored data and data recorded to the blockchain, and reconcile or flag them for correction by an administrator. Next, the VEZT platform displays available ISOs to the user (step 2816). The VEZT platform then receives a selection of an available rights purchase from the user device (step 2820). The VEZT platform responsively updates the user wallet and local User and Transaction Databases with this transaction data and prepares a smart digital contract for this transaction (step 2822). The transaction data is then batched in the FIFO queue for later blockchain submission (step 2824). Periodically or upon reaching one or more programmed conditions, such as data size or bandwidth requirements, the VEZT platform then writes all new transaction data to the blockchain storage system (step 2826), after which this instance of the process 2800 ends. Issuing transactions on the network happens through API requests made by our application software layer to our domain software layer. In order to ensure proper functioning of transactions on the network, we have engineered a first-in, first-out (FIFO) queue to process each of the necessary functions we need in the order required. Through this domain logic we then issue calls to our transaction layer to prepare, sign and broadcast the transactions on the blockchain network in an orderly fashion. There are certain functions that require a preceding function to have succeeded in order for it to succeed, so we enforce a strict order to transaction processing to maintain proper state of the user's transaction in our system. When one of these transaction types is encountered, we issue a linking ID that allows the current process to track the state of the requisite transaction on the blockchain network and report back to our workers in the domain layer that such action has occurred.

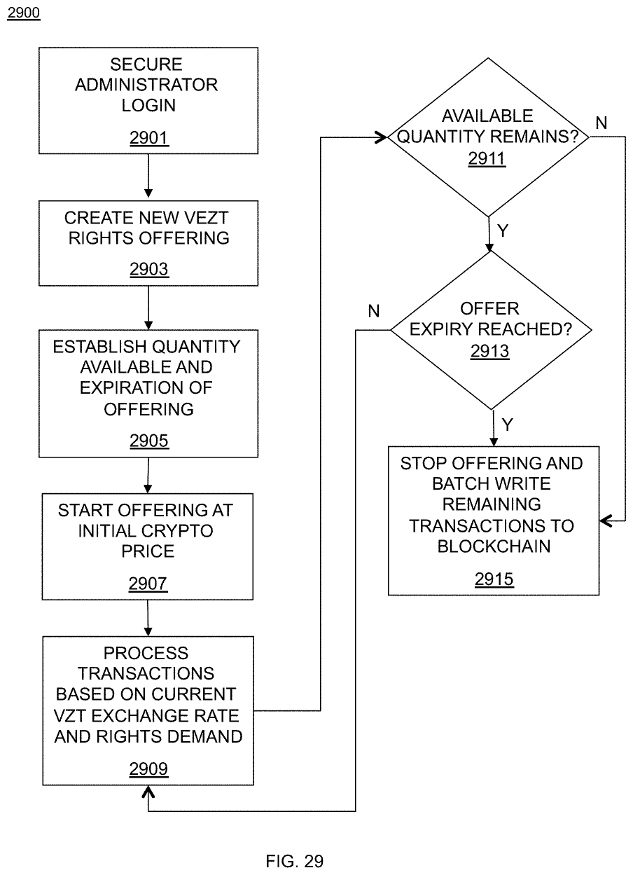

Turning to FIG. 29, therein is depicted an exemplary ISO Creation Process 2900 according to various embodiments of the present disclosure. The process 2900 commences at step 2901 when a valid VEZT platform administrator securely logs into the VEZT platform using an administrator communication device. The administrator next creates a new VEZT rights offering (step 2903). The administrator then enters the rights quantity available, pricing (in VZT) and start/expiration of offer (step 2905), which may be stored in the VEZT Offering and INITIAL SONG OFFERING, and where appropriate, the Offering Waitlist Databases of FIG. 10. When a commencement date is reached for the entered offering, the ISO commences at the initial set VZT price (step 2907). The VEZT platform then processes subsequent transactions based on a current floating VZT exchange rate from the cryptocurrency spot market, as well as currents rights demand for current offering, which affects the exchange price of the Song Token corresponding to the offering with regard to the VZT token (step 2909). When each transaction is completed, the VEZT platform next determines whether any available quantity of offering remains (step 2911). If so, the process 2900 continues to step 2913, and otherwise, the process 29000 continues to step 2915, later below. At step 2913, the VEZT platform determines if an offer expiry time for the offering has been reached. If so, the process continues to step 2915. Otherwise, the process 2900 returns to step 2909 above. Finally, at step 2915, the VEZT platform stops the offering and batch writes any remaining unwritten transaction to the blockchain storage system, after which the process 2900 ends.

In order to begin a new offering on the VEZT platform, a new offering from our centralized database needs to fulfill certain criteria that are approved by a VEZT administrator (i.e. rights information, percentage sold, sales price, etc.). Once this information is verified, the offering is selected for launch and a CREATE_OFFERING transaction is created. This offering will now be available for interaction in our application albeit in a format that will not accept contributions. This allows offerings to be visible on the blockchain. Once an offering is in a state that can accept contributions, we issue a START_OFFERING transaction to being the sale of the offering. No contribution will be allowed on the offering until these actions have occurred. Once an offering has expired, sold out, or canceled, we issue a STOP_OFFERING transaction to halt contributions to the offering once more. When a STOP_OFFERING transaction is issued, a reversion period start date is issued to the offering and all contributions made will begin the process of tracking the royalty income earned for the stake calculated at the time the contribution was made. During the course of a live offering, CONTRIBUTION transactions will be made via the smart contract which will enter the system via our application layer. Payment is accepted in the form of fiat currency as processed through a payment gateway/merchant provider and through the use of VZT, in the form of an ERC-20 token as issued proprietarily by the VEZT platform in exchange for various currencies. The use of each form of payment has a slightly different flow. When a user opt to pay with fiat currency via one of our authorized payment gateways, we issue a VALID_FIAT_CONTRIBUTOR action on a user which then allows a user to spend on the platform through a managed funding source. Alternatively, for VZT users, when they make their first purchase on the platform, we issue a VALID_VZT_CONTRIBUTOR action, which then triggers an APPROVE_SPENDING transaction which must succeed before any other transaction can be made by that user. Once both of these transactions succeed for a VZT spender, then they are allowed to spend on the platform using their personal funding source.

The following exemplary data formats may be used for batch writing to the blockchain of transaction data as described above:

reversionPeriodStart=>Activation date of rights ownership to contributors

reversionPeriodEnd=>Termination date of rights ownership to contributors when/if contribution amount is recovered

isActive=>Indicates if the Vezt offering is currently active or not

amountRaised=>Total amount to be raised in the Vezt offering

uniqueId=>Unique id for a Vezt offering

contributorId=>wallet_id associated to a Vezt User—intent is to always keep a record of the wallet that contributed

contributionAmount=>Amount contributed/purchased in a Vezt offering

stakePurchased=>Pro-rata percentage stake of entire Vezt offering

veztOfferingId=>Vezt specific id of offering being purchased

Regarding database operations as described in various places in the foregoing, the following common functions may be utilized to perform those functions as described. The jQuery get( ) and post( ) methods may be used to request data from the server with an HTTP GET or POST request. Two commands for a request-response between a client and server are: GET and POST. GET requests data from a specified resource. POST submits data to be processed to a specified resource. GET is basically used for just getting (retrieving) some data from the server. The GET method may return cached data. POST can also be used to get some data from the server. However, the POST method NEVER caches data, and is often used to send data along with the request.

The $.get( ) method requests data from the server with an HTTP GET request.

Syntax: $.get(URL, callback)

The required URL parameter specifies the URL to be requested. The optional callback parameter is the name of a function to be executed if the request succeeds. The first parameter of $.get( ) is the URL being requested (i.e., “demo_test.asp”). The second parameter is a callback function. The first callback parameter holds the content of the page requested, and the second callback parameter holds the status of the request.

The $.post( ) method requests data from the server using an HTTP POST request.

Syntax: $.post(URL, data,callback);

The required URL parameter specifies the URL you wish to request. The optional data parameter specifies some data to send along with the request. The optional callback parameter is the name of a function to be executed if the request succeeds. The first parameter of $.post( ) is the URL being requested (“demo_test_post.asp”). Then data is passed to send along with the request (name and city). An exemplary ASP script in “demo_test_post.asp” reads the parameters, processes them, and returns a result. The third parameter is a callback function. The first callback parameter holds the content of the page requested, and the second callback parameter holds the status of the request.

As described herein, operation of a memory device (e.g., memory 34), may include physical transformations such as a change in state from a binary one to a binary zero (or vice versa) and may comprise a visually perceptible physical transformation. The transformation may comprise a physical transformation of an article to a different state or thing. For example, a change in state may involve accumulation and storage of charge or release of stored charge. Likewise, a change of state may comprise a physical change or transformation in magnetic orientation, or a physical change or transformation in molecular structure, such as from crystalline to amorphous or vice versa.

In summary, the VEZT platform, through its unique programming and network structure achieves an improved machine-controlled process for securely recording user requests locally and in a secure and efficient manner to blockchain storage systems. Through centralized technology, proprietary applications have been developed and will be distributed regarding the process described herein. Such API layer software and blockchain operations have use in many industrial applications other than those described herein. Through proprietary offerings of VZT tokens, users may enter into transactions involving offerings provided via the VEZT platform, be they for song rights or other types of royalty-generating copyrightable works. As described herein, user wallets store such VZT tokens, which have a spot price as determined by cryptocurrency spot markets. Users may have one-to-many wallets on the platform. User wallets however, have a private key that, for security purposes is not maintained on the VEZT platform, but rather on the user device. User wallet transactions may be batch submitted for blockchain storage. VZT tokens may be exchanged for dedicated Song Tokens when making an ISO purchase during an offering as described herein Like the VZT token, the value of the Song Token will float based on demand for such tokens, as well as popularity of the work to which the song token is attached and any royalties that are generated for distribution therefrom. Such values will operate in a similar manner to established cryptocurrency spot markets and through similar programmed functionalities. The tokenized song rights are also memorialized in smart contracts as described above. The smart contracts are stored within the VEZT platform, but for security, cost, bandwidth consumption and accommodating future evolutions of such smart contracts, are never stored in their entirety on the blockchain. Instead, the relevant terms and the type or version of the contract may be established as metadata and stored in that manner in the blockchain for independent verification. This prevents circumstances from developing over time where version storage errors arise or where, for example, the terms of smart contracts may be allowed to change in future offerings while stored values remain consistent so that programming for storing the same does not have to be change with the evolving contract versions. At the close of an ISO, all unwritten transactions are batched for submission to the blockchain, but individual ownership may not be fully registered, or only partly registered as metadata as described previously, until such batch submission is complete. During this interim period, fund distributions and ownership details relating to an ISO, while stored locally and available for viewing by users through the VEZT platform immediately, may be delayed until batch submission to the blockchain is complete and confirmed.

The foregoing disclosure discloses proposed and implemented models and technology for maintaining, for example, hybridized music rights in a blockchain ledger, which functionality is ideally agnostic as to particular existing blockchain providers. A technological problem encountered in the implementation of a music rights marketplace is how to maintain records of hundreds of thousands of records of such rights on a blockchain ledger in a manner that is both computationally and energy efficient, considering that there are a variety of block chain networks that may serve as a public ledger.

In the foregoing, the first generations of the VEZT platform depended in various embodiments on a proof of work (POW) public blockchain ledger provider, known as ETHEREUM, which relied on a decentralized smart contract that acted as a ledger to record the purchase period of the rights for a song as well as a variety of additional administrative functionalities. The following functionalities were in place for these first generations and thereafter: (i) add offerings to be publicly available on the blockchain with a unique identifier that is cross-referenced with the VEZT platform's centralized non-blockchain databases; (ii) toggle contribution periods per ISO basis, i.e., ‘start’ an offering and allow others to buy into the ISO automatically using their VZT utility tokens if they so choose, and (iii) ‘close’ an offering to prevent users from buying into it after the offering has ended.

In the foregoing, the first generations of the VEZT platform enabled purchasing of ISO song rights using either fiat currency or any of a variety of cryptocurrencies, including, for example, the VZT token. Fiat purchases were performed with a VEZT platform-provided administrative wallet and any other crypto purchases were pre-signed by the user's own external digital wallet. In order to maintain total security, no such external user digital wallet information was stored in the VEZT platform's centralization layer.

Also in the foregoing descriptions of the first generations of the VEZT platform, administrative functionality was provided to prevent certain users from purchasing rights if abuse of the system is detected, as well as to differentiate between purchases using either fiat currency or VZT. IN particular, all users must be ‘validated’ for an ISO contract before being able to have contributions attributed to them. These validations allow the VEZT platform to revoke user credentials later on if necessary for any number of reasons ranging from support to abuse. This also allows the VEZT platform to hone into a predictable pattern that can be utilized in other blockchains, besides ETHEREUM, that may be selected for actual implementation.

Finally, first generations of the VEZT platform included look-up functionality, which may be used by administrators, users, rights holders and third parties to verify any of the millions of VEZT platform transaction records stored on the blockchain ledger.

After implementation of the first generations of the VEZT platform, and due to the high volume of purchases encountered on the platform, it was concluded that relying on any PoW blockchains, such as ETHEREUM in its current state, would unduly bog down transaction processing. In response, as a technological solution to this technological problem, these first generation VEZT platform functionalities were re-configured to be blockchain agnostic in the latest generation of the VEZT platform.

To accomplish this, the core logic of the transparency layer on the blockchain was designed to abstract away from the specific chain and focus more on the act of a transaction for a contribution itself. This allows the VEZT platform to defer transaction processing to a separate ‘always running’ worker application instance. This worker instance allows the VEZT platform to continuously process payment transactions and offering listings separate from the centralized music listing layer.

One specific programming structure for accomplishing such agnostic functionalities is as follows:

[Centralized Listing managed by VEZT platform]

Handles transport layer of information in scalable environment where the VEZT platform holds the unique identifiers for all ISO listings.

Intent to purchase rights are recorded on the VEZT platform's centralized layer first.

[Decentralized/Blockchain layer—Chain agnostic]

Writes rights purchase contribution transactions, and listings to the chosen blockchain layer by referencing the unique identifier generated by the VEZT platform's centralization layer.

Writes are deferred and happen after the fact of an initial intent is recorded on the centralized layer and then are separately processed onto the chain by recording the initial blockchain transaction information, as well as the success status of the transaction, by querying the blockchain itself.

Ability to represent song rights as their own blockchain asset to be redeemed by transactions referring to the original rights contribution transaction.

Various embodiments of the next generation of VEZT platform may employ the Stellar (XLM) protocol, which in use, provided an over ten-fold increase in throughput bandwidth for transaction processing, thus also decreasing network bandwidth consumption.

In the first generations of the VEZT platform, the unique transaction identifiers generated in the centralized layer were written onto each contribution object stored in the ISO smart contract. In the next generation of the VEZT platform, on the other hand, each transaction is instead categorized by a ‘memo’ transaction attribute that comprises the unique ID instead. Both approaches allow the VEZT platform to cross-reference transactions against those stored through the VEZT platform's centralized layer, and verify the validity of a purchase by both the original sender of the transaction (i.e., a VZT administrative wallet) and the unique ID itself.

The following advantages were most apparent after switching over to the Stellar Protocol:

1) Transaction processing time was cut from and observed range of three minutes to six hours in the first generations of the VEZT platform, to anywhere between two seconds and only one minute thirty second;

2) Cost of writing to the block chain was reduced from thirty cents per transaction to one cent per 300,000 transactions;

3) Improved administrative control allows the VEZT platform to freeze assets to any account with only one transaction, as opposed to a multi-step three-transaction process as employed in the first generations of the VEZT platform; and;

4) stream-lined implicit functionality has been put in place for issuing assets that represent the song rights purchased by users from the issuer source as opposed to releasing an ERC-721 ETHEREUM token or asset that suffers from the same network bottlenecks that other writes on the ETHEREUM blockchain face.

The next generation of the VEZT platform is now able to maintain parity and backwards compatibility with any of the varying blockchain systems as needed because all contributions and offerings are referred to by a unique id generated from the VEZT platform's centralization layer. If a user contributed to an offering utilizing the first generations of the system as opposed to the next generation, for example, the VEZT platform can still verify the validity of their purchase on the origin chain where their transaction was first recorded, mainly because the records on the original chain remain immutable.

The same source of truth for all contributions and offerings is used for all blockchain layers. Since the blockchain operations are deferred from the VEZT platform's centralization layer and agnostic to whatever centralized or decentralized blockchain technology being used, the VEZT platform can issue asset representations of ISO offerings as is necessary. Blockchains already represent these assets any number of ways, such as ERC-721 ETHEREUM assets or STELLAR assets. The VEZT platform system allows the extension and creation of these assets from the VEZT platform, which can then be exchanged between users on the blockchain where they originated.

Aspects of the disclosed embodiments may be described in terms of algorithms and symbolic representations of operations on data bits stored on memory. These algorithmic descriptions and symbolic representations generally include a sequence of operations leading to a desired result. The operations require physical manipulations of physical quantities. Usually, though not necessarily, these quantities take the form of electrical or magnetic signals capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

While embodiments have been described in the context of fully functioning computers, those skilled in the art will appreciate that the various embodiments are capable of being distributed as a program product in a variety of forms, and that the disclosure applies equally regardless of the particular type of machine or computer-readable media used to actually effect the distribution.

While the disclosure has been described in terms of several embodiments, those skilled in the art will recognize that the disclosure is not limited to the embodiments described herein and can be practiced with modifications and alterations within the spirit and scope of the invention. Those skilled in the art will also recognize improvements to the embodiments of the present disclosure. All such improvements are considered within the scope of the concepts disclosed herein. Thus, the description is to be regarded as illustrative instead of limiting.

The disclosed teachings relate to methods and systems for improving the operability of computer network functions, which are necessary and useful in various real-world applications including, inter alia, and as but one of a wide variety of useful examples, a platform for operating a marketplace that utilizes intellectual property rights of copyrightable works as currency for owners of the works, which in turn enables rights owners to access additional resources. The embodiments set forth above enable those skilled in the art to practice the embodiments and illustrate the best mode of practicing the embodiments. Upon reading the description in light of the accompanying figures, those skilled in the art will understand the concepts of the disclosure and will recognize applications of these concepts that are not particularly addressed herein. It should be understood that these concepts and applications fall within the scope of the disclosure.

What is claimed is:

1. An enhanced computer memory system for use in improving a distributed data communication network that provides transparent access to securely-recorded data while minimizing network bandwidth usage and consumed processing power, comprising:
a network server system having at least one processor in operative connection with electronic memory for storing specially-programmed processing instructions and customized databases that are processed by the processor, and a network communication interface for communicating processing instructions and requests between the network server system and remote computing devices over the communication network, the network server system further hosting a publicly-accessible website having a network address on the communication network, the website causing a graphical user interface to be displayed on displays of the remote processing devices for submitting instructions and requests there-through and presenting immediate confirmations thereon;
the network server system allowing remote computing devices of a plurality of users visiting the website to transmit processing requests to, and responsively receive output instructions from, the network server system via the network communication interface over the communication network, the processing requests and output instructions stored in the customized databases and immediately accessible via the website thereafter;
the network server system further communicating with a blockchain distributed storage system via the network communication interface for selectively and verifiably storing output instructions generated by the network server system in response to processing requests received from the plurality of remote computing devices, the blockchain distributed storage system being accessible to the remote computing devices over the Internet separately from the website;
the specially programmed processing instructions providing an improvement that enables the processor of the network server system to:
receive a processing request from a remote computing device via the website;
store the processing request in the customized databases, where receipt of the processing request is immediately verifiable by the remote computing device via the website;
determine output instructions based on the processing request received from the remote computing device, the output instructions comprising at least one field enhancement of the customized databases generated by computing the processing request in accordance with a variable stored in the customized databases referenced by the processing request;
store the output instructions in the customized databases, the output instructions being immediately verifiable by the remote computing device via the website;
generate confirmation instructions by calculating at least one of a checksum value and a hash value from at least a portion of the output instructions, where the confirmation instructions comprise a smaller data size than a data size of the output instructions in order to preserve network bandwidth usage, where the confirmation instructions can be used to verify a validity of the output instructions;
transmit the confirmation instructions via the network communication interface to the blockchain distributed storage system for permanent and unalterable storage, the confirmation instructions thereafter being accessible by the remote computing device from the blockchain distributed storage system over the communication network without accessing the website;
generate a plurality of additional confirmation instructions generated from additional output instructions that relate to additional processing requests received from a plurality of additional remote computing devices via the network communication interface; and
transmit the output instructions with the additional output instructions as a batch submission, at a later time than the storing of the confirmation instructions, via the network communication interface to the blockchain distributed storage system for permanently and unalterably storing the output instructions and the additional output instructions such that consumed processing power is lower than if the output instructions and the additional output instructions were transmitted separately to the blockchain data storage system, where the output instructions and the additional output instructions are thereafter publicly accessible via the blockchain distributed storage system without accessing the website, and the output instructions are verifiable by any remote computing device using the confirmation instructions, whereby
the network server system, the remote computing devices and the blockchain distributed storage system form, via implementation of specially-programmed processing instructions, an improved distributed computing network that provides immediate availability of confirmation of processing requests and permanent storage of output instructions generated from received processing requests in a manner that conserves bandwidth and lowers consumed processing power.

2. The enhanced memory system of claim 1, the specially programmed processing instructions further enabling the processor to:
receive, from an external data source, update instructions for updating the variable in the customized database via the network communication interface;
responsively generate updated output instructions based on the update instructions and a value of the variable, the updated output instructions comprising at least one field enhancement of the customized databases generated by computing the output instructions in accordance with the variable as updated in response to the update instructions;
store the updated output instructions in the customized databases, the updated output instructions being immediately verifiable by the remote computing device via the website;
generate updated confirmation instructions by calculating at least one of a checksum value and a hash value from at least a portion of the updated output instructions, where the confirmation instructions comprise a smaller data size than a data size of the output instructions in order to preserve network bandwidth usage, where the updated confirmation instructions can be used to later verify a validity of the updated output instructions available from the website;
transmit the updated confirmation instructions via the network communication interface to the blockchain distributed storage system for permanent and unalterable storage on a blockchain thereof, the updated confirmation instructions thereafter being accessible by the remote computing device from the blockchain distributed storage system over the communication network without accessing the website;
generate a plurality of additional updated confirmation instructions generated from additional updated output instructions that relate to additional update instructions received from external sources; and
transmit the updated output instructions with the additional updated output instructions as a second batch submission, at a later time than the storage of the updated confirmation instructions, via the network communication interface to the blockchain distributed storage system for permanently and unalterably storing the updated output instructions and the additional updated output instructions such that consumed processing power is lower than if the updated output instructions and the additional updated output instructions were transmitted separately to the blockchain data storage system, where the updated output instructions and the additional updated output instructions are thereafter publicly accessible via the blockchain distributed storage system without accessing the website, and the updated output instructions are verifiable by any remote computing device using the updated confirmation instructions.

3. The enhanced memory system of claim 1, where the network server system is used in conjunction with at least one of: financial services, banking services, investment services, exchange trading services, currency exchange services, contract recordation services, purchase verification and fulfillment operations, cargo tracking systems, medical record storage, electronic voting systems, census recording, government records storage, and data integrity storage services.

4. The enhanced memory system of claim 1, where the confirmation instructions and the output instructions are separately written to a publicly-accessible blockchain maintained by the blockchain distributed storage system.

5. The enhanced memory system of claim 4, where the processing request relates to a purchase transaction initiated by the user.

6. The enhanced memory system of claim 5, where the output instructions relate to generating a contract involving the purchase transaction for output to a display of the remote processing device.

7. The enhanced memory system of claim 6, where the checksum value and the hash value are used to confirm that the output instructions as stored in the blockchain distributed storage system have not been altered since they were generated by the network server system.

8. The enhanced memory system of claim 5, where the user maintains an electronic wallet on the blockchain.

9. The enhanced memory system of claim 8, where the update instructions relate to a transfer of a currency value to the electronic wallet in accordance with the output instructions.

10. The enhanced memory system of claim 9, wherein the currency value comprises a cryptocurrency value.

11. The enhanced memory system of claim 5, where the purchase transaction relates to purchasing a fractional ownership interest in royalty rights to a copyrighted work.

12. The enhanced memory system of claim 11, where the variable comprises a value determined in accordance with a measured demand for the copyrighted work.

13. The enhanced memory system of claim 11, where the copyrighted work comprises a musical work.

14. The enhanced memory system of claim 13, where the musical work comprises a sound recording.

15. The enhanced memory system of claim 14, where the value is determined in accordance with a measured demand of the musical work relative to other musical works.

16. The enhanced memory system of claim 11, the specially programmed processing instructions further enabling the processor to:
transmit, to the remote computing device in response to the processing request, a display of form data that automatically populates one or more templates with terms of a contract for at least one of a sale and license to the royalty rights stored in the customized databases; and
receive a completed form from the remote processing device via the network communication interface, the completed form including field enhancements to the customized databases related to the user, where the completed form is used at least in part to generate the output instructions.

17. The enhanced memory system of claim 11, where the update instructions relate to a distribution of royalty payments for the copyrighted work.

18. The enhanced memory system of claim 11, the specially programmed processing instructions further enabling the processor to:
determine a demand rank of the copyrighted work relative to other copyrighted works; and
update the demand rank for the copyrighted work on the website.

19. An enhanced computer memory system for use in improving a distributed data communication network that provides transparent access to securely-recorded data while minimizing network bandwidth usage and consumed processing power, comprising:
a network server system having at least one processor in operative connection with electronic memory for storing specially-programmed processing instructions and customized databases that are processed by the processor, and a network communication interface for communicating processing instructions and requests between the network server system and remote computing devices over the communication network, the remote computing devices comprising at least one of a personal computing device and a smartphone, the network server system further hosting a publicly-accessible website having a network address on the communication network, the website causing a graphical user interface to be displayed on displays of the remote processing devices for submitting instructions and requests there-through and presenting immediate confirmations thereon;
the network server system allowing remote computing devices of a plurality of users visiting the website to transmit processing requests to, and responsively receive output instructions from, the network server system via the network communication interface over the communication network, the processing requests and output instructions stored in the customized databases and immediately accessible via the website thereafter;
the network server system further communicating with a blockchain distributed storage system via the network communication interface for selectively and verifiably storing output instructions generated by the network server system in response to processing requests received from the plurality of remote computing devices, the blockchain distributed storage system being accessible to the remote computing devices over the communication network separately from the website;
the specially programmed processing instructions providing an improvement that enables the processor of the network server system to:
receive a processing request from a remote computing device via the website;
store the processing request in the customized databases, where receipt of the processing request is immediately verifiable by the remote computing device via the website;
determine output instructions based on the processing request received from the remote computing device, the output instructions comprising at least one field enhancement of the customized databases generated by computing the processing request in accordance with a variable stored in the customized databases referenced by the processing request;
store the output instructions in the customized databases, the output instructions being immediately viewable by the remote computing device via the website;
generate confirmation instructions by calculating at least one of a checksum value and a hash value from at least a portion of the output instructions, where the confirmation instructions comprise a smaller data size than a data size of the output instructions in order to preserve network bandwidth usage, where the confirmation instructions can be used to verify a validity of the output instructions stored by the website;
transmit the confirmation instructions via the network communication interface to the blockchain distributed storage system for permanent and unalterable storage, the confirmation instructions thereafter being accessible by the remote computing device from the blockchain distributed storage system over the communication network without accessing the website;
generate a plurality of additional confirmation instructions generated from additional output instructions that relate to additional processing requests received from a plurality of additional remote computing devices via the network communication interface; and
transmit the output instructions with the additional output instructions as a batch submission, at a later time than the storing of the confirmation instructions, via the network communication interface to the blockchain distributed storage system for permanently and unalterably storing the output instructions and the additional output instructions on a publicly-accessible blockchain, such that consumed processing power is lower than if the output instructions and the additional output instructions were transmitted separately to the blockchain data storage system, where the output instructions and the additional output instructions are thereafter publicly accessible via the blockchain distributed storage system without accessing the website, and the output instructions are verifiable by any remote computing device using the confirmation instructions.

20. A method for improving a distributed data communication network that provides transparent access to securely-recorded data while minimizing network bandwidth usage and consumed processing power, including a network server system having at least one processor in operative connection with electronic memory for storing specially-programmed processing instructions and customized databases that are processed by the processor, and a network communication interface for communicating processing instructions and requests between the network server system and remote computing devices over the communication network, the network server system further hosting a publicly-accessible website having a network address on the communication network, the website causing a graphical user interface to be displayed on displays of the remote processing devices for submitting instructions and requests there-through and presenting immediate confirmations thereon, the method comprising:
receiving a processing request from a remote computing device via a website;
storing the processing request in a customized database, where receipt of the processing request is immediately verifiable by the remote computing device via the website;
determining output instructions based on the processing request received from the remote computing device, the output instructions comprising at least one field enhancement of the customized database generated by computing the processing request in accordance with a variable stored in the customized database that is referenced by the processing request;
storing the output instructions in the customized database, the output instructions being immediately verifiable by the remote computing device via the website;
generating confirmation instructions by calculating at least one of a checksum value and a hash value from at least a portion of the output instructions, where the confirmation instructions comprise a smaller data size than a data size of the output instructions in order to preserve network bandwidth usage, where the confirmation instructions can be used to verify a validity of the output instructions;
transmitting the confirmation instructions via a network communication interface to a blockchain distributed storage system for permanent and unalterable storage, the confirmation instructions thereafter being accessible by the remote computing device from the blockchain distributed storage system over the communication network without accessing the website;
generating a plurality of additional confirmation instructions generated from additional output instructions that relate to additional processing requests received from a plurality of additional remote computing devices via the network communication interface; and
transmitting the output instructions with the additional output instructions as a batch submission, at a later time than the storing of the confirmation instructions, via the network communication interface to the blockchain distributed storage system for permanently and unalterably storing the output instructions and the additional output instructions such that consumed processing power is lower than if the output instructions and the additional output instructions were transmitted separately to the blockchain data storage system, where the output instructions and the additional output instructions are thereafter publicly accessible via the blockchain distributed storage system without accessing the website, and the output instructions are verifiable by any remote computing device using the confirmation instructions.
